(19) United States
(12) Patent Application Publication
(10) Pub. No.: US 2023/0295927 A1
(43) Pub. Date: Sep. 21, 2023

(54) HYDROPHOBIC GRANULES AND RELATED ARTICLES AND METHODS

(71) Applicant: 3M INNOVATIVE PROPERTIES COMPANY, St. Paul, MN (US)

(72) Inventors: Rachael A.T. Gould, Forest Lake, MN (US); John S. Edwards, Hudson, WI (US); Christian A. Jolicoeur, Minneapolis, MN (US)

(21) Appl. No.: 18/122,853

(22) Filed: Mar. 17, 2023

Related U.S. Application Data
(60) Provisional application No. 63/320,974, filed on Mar. 17, 2022.

(51) Int. Cl. E04D 7/00; C09C 3/12; C09C 3/06

(52) U.S. Cl. CPC E04D 7/005; C09C 3/12; C09C 3/063

(57) ABSTRACT

Granules include a hydrophobic surface treatment. The hydrophobic surface treatment may include a hydrocarbon oil and a silicon-containing polymer, in which the hydrocarbon oil is present in an amount of at least 0.025 percent by weight, and the silicon-containing polymer is present in an amount of greater than 0.05 percent by weight of the roofing granules. The hydrophobic surface treatment may include silicon-containing polymer present in an amount of greater than 0.05, greater than 0.25 percent, or greater than 0.5 percent by weight of the roofing granules. Use of the granules as roofing granules is also disclosed. A construction article includes a substrate, an organic coating, and the roofing granules at least partially embedded in the organic coating. Methods of making the granules and the construction article are also disclosed.

### CROSS-REFERENCE TO RELATED APPLICATION

This application claims priority to U.S. Provisional Application No. 63/320,974, filed Mar. 17, 2022, the disclosure of which is incorporated by reference in its entirety herein.

### BACKGROUND

Inorganic granules are commonly used on granule-surfaced bituminous roll roofing and asphalt shingles. The granules, which are partially embedded in one surface of asphalt-impregnated shingles or asphalt-coated fiber sheet material, form a coating which can provide useful properties, for example, weather-resistance, fire resistance, and desirable aesthetics. The layer of roofing granules can function as a protective layer to shield the bituminous material and the base material from both solar (e.g., ultraviolet radiation) and environmental degradation.

Granules are often produced and selected to provide a desirable color to a finished structure or building. It is desirable that the color be consistent over time in order to maintain the appearance of the building; however, discoloration of roofing shingles and other building materials can result from algae infestation. Algae tend to grow on building materials in areas where moisture is retained. Discoloration (e.g., in the form of black streaks) has commonly been attributed to blue-green algae, Gloeocapsa spp., transported as air-borne particles. The infestation may be particularly acute on asphalt shingles.

Copper compound particles are added to coatings to form algae resistant coatings. The copper ions in the compounds are released, or leached, over time as the coating is subjected to weathering and water.

Roofing granules including photocatalytic particles are disclosed in U.S. Pat. No. 6,569,520 (Jacobs). Shingles with low-density granules, backdust, or aggregate are disclosed in U.S. Pat. No. 7,805,909 (Teng et al.) and U.S. Pat. No. 9,279,255 (Bryson et al.). Shingles with increased hydrophobicity are disclosed in U.S. Pat. No. 10,865,565 (Smith et al.) and U.S. Pat. No. 11,124,968 (Vermillion et al.). Stain-resistant roofing granules are disclosed in U.S. Pat. No. 5,240,760 (George et al.) and U.S. Pat. Appl. Pub. No. 2021/0270036 (Kragten et al.). Roofing shingles having agglomerated microorganism-resistant granules are disclosed in U.S. Pat. Appl. Pub. No. 2008/0131664 (Teng et al.).

### SUMMARY

The price of copper oxide and other copper materials useful for making algae-resistant materials is rising. It is therefore desirable to reduce the amount of copper compounds needed, for example, to make algae-resistant construction products such as algae-resistant asphalt shingles and roll-roofing products. Although this disclosure is not to be bound by any theory, it is believed that the granules disclosed herein typically and advantageously can reduce the level of moisture retained on a roofing material, which moisture is necessary for algae growth and photosynthesis. Through use of the granules described herein, the quantity of copper required on the roofing material may be minimized or, in some cases, eliminated.

In one aspect, the present disclosure provides granules including a hydrophobic surface treatment. The hydrophobic surface treatment includes a hydrocarbon oil and a silicon-containing polymer. The hydrocarbon oil is present in an amount of at least 0.025 percent by weight of the granules, and the silicon-containing polymer is present in an amount of greater than 0.05 percent by weight of the granules.

In another aspect, the present disclosure provides granules including a hydrophobic surface treatment. The hydrophobic surface treatment comprises a silicon-containing polymer. If the granules have a surface color different from an interior color, the silicon-containing polymer is present in an amount of greater than 0.25 percent by weight of the granules, and if the roofing granules are porous, the silicon-containing polymer is present in an amount of greater than 0.5 percent by weight of the granules.

In another aspect, the present disclosure provides a blend of porous, mineral-based granules and the granules having a hydrophobic surface treatment. The porous, mineral-based granules may or may not have a hydrophobic surface treatment.

The granules of the present disclosure may have one or more of the following features: an infrared light-reflective coating, a coating comprising a biological growth inhibitor, a coating comprising a photocatalytic particle, a coating comprising a pigment, or a combination thereof “Combinations thereof” include blends of granules that have some granules with one type of coating and other granules with a different type of coating as well as granules having multiple types of coatings on the same granules.

In another aspect, the present disclosure provides use of the granules described herein, which include the granules having a hydrophobic surface treatment as described in any of the above aspects or blend of the granules and porous, mineral-based granules as roofing granules.

In another aspect, the present disclosure provides a construction article including a substrate, an organic coating, and the aforementioned granules or blend of granules.

In another aspect, the present disclosure provides a process for making the granules of the present disclosure. The process includes combining granules, the silicon-containing polymer or a precursor thereof, and optionally the hydrocarbon oil to provide a mixture and at least one of heating or drying the mixture to provide the granules having a hydrophobic surface treatment.

In another aspect, the present disclosure provides a process of making a construction article of the present disclosure. The process includes applying an organic coating on a substrate and applying the granules of the present disclosure in any of their embodiments to the organic coating.

In another aspect, the present disclosure provides a method of reducing algae growth on a construction surface. The method includes applying the construction article of the present disclosure onto the construction surface.

As Used Herein:

Terms such as “a”, “an” and “the” are not intended to refer to only a singular entity but include the general class of which a specific example may be used for illustration. The terms “a”, “an”, and “the” are used interchangeably with the term “at least one”.

The phrase “comprises at least one of” followed by a list refers to comprising any one of the items in the list and any combination of two or more items in the list. The phrase “at least one of” followed by a list refers to any one of the items in the list or any combination of two or more items in the list.

The term “mineral” refers to a naturally occurring inorganic substance with a uniform chemical composition (either an element (non-metallic) or a compound) and a regularly repeating atomic structure. Thus, the term “mineral” excludes glasses. Minerals are generally formed from geological processes. A rock is an aggregate of one or more minerals. Thus, the term “mineral-based” includes minerals and rocks.

The term “polymer” refers to a molecule having a structure which includes the multiple repetition of units derived, actually or conceptually, from one or more monomers. The term “monomer” refers to a molecule of low relative molecular mass that can combine with others to form a polymer. The term “polymer” includes homopolymers and copolymers, as well as homopolymers or copolymers that may be formed in a miscible blend. The term “polymer” includes random, block, graft, and star polymers. The term “polymer” includes oligomers.

The term “porous” refers to including pores, generally throughout the granules. Pores throughout the granules can generally be observed visually, either with the naked eye or using a microscope, after cross-sectioning the granules. Porosity can be measured by mercury porosimetry or equivalent method. Porosity is also related to moisture absorption.

All numerical ranges are inclusive of their endpoints and non-integral values between the endpoints unless otherwise stated (e.g., 1 to 5 includes 1, 1.5, 2, 2.75, 3, 3.80, 4, 5, etc.). The above summary of the present disclosure is not intended to describe each disclosed embodiment or every implementation of the present disclosure. The description that follows more particularly exemplifies illustrative embodiments. It is to be understood, therefore, that the drawings and following description are for illustration purposes only and should not be read in a manner that would unduly limit the scope of this disclosure.

### BRIEF DESCRIPTION OF THE DRAWING

FIG. 1 shows a granule having a hydrophobic polymeric coating according to an embodiment of the present disclosure;

FIG. 2 shows a blend of granules according to another embodiment of the present disclosure;

FIG. 3 is a side view of one embodiment of a construction article of the present disclosure;

FIG. 4 is a schematic view of another embodiment of a construction article of the present disclosure;

FIG. 5a is a top schematic view of the three-tab panel layout used in the Outdoor Evaluations in the Examples;

FIG. 5b is side view of the panel stand used in the Outdoor Evaluations in the Examples;

FIG. 6 is a representation of the tab surface observed in Outdoor Evaluation 1 of Illustrative Example 7;

FIG. 7 is a representation of the tab surface observed in Outdoor Evaluation 1 of Example 9; and

FIG. 8 is a representation of the tab surface observed in Outdoor Evaluation 1 of Comparative Example 10.

### DETAILED DESCRIPTION

The granules useful for the roofing granules and articles of the present disclosure may include a variety of materials. The granules may be inorganic and selected from a wide class of rocks, minerals, recycled materials, and combinations thereof. Examples of rocks and minerals include basalt, diabase, gabbro, argillite, rhyolite, dacite, latite, andesite, greenstone, granite, silica sand, slate, nepheline syenite, quartz, quartzite, gannister, slag (e.g., coal slag, copper slag, and nickel slag), feldspar, common gravel, and combinations thereof. The granules typically have a particle size in the range of about 300 micrometers (μm) to about 1800 μm or to about 2400 μm. In some embodiments, the granules have a size distribution in which at least 90 percent, at least 95 percent, or at least 97 percent of the granules are in the range of about 300 μm to about 1800 μm or to about 2400 μm. Larger samples may be crushed and screened, for example, to achieve a size within a range useful for roofing granules. The size distribution of granules is measured with an industry standard sieve shaker for five minutes using standard sieves. For irregularly shaped granules, the size is considered to be the largest dimension (e.g., longest axis of an ellipse). The granules can have a bulk density of at least 80 pounds per cubic foot (1.28 g/cc), in some embodiments, a range from 80 pounds per cubic foot (1.28 g/cc) to 120 pounds per cubic foot (1.92 g/cc) or 90 pounds per cubic foot (1.44 g/cc) to 100 pounds per cubic foot (1.60 g/cc), and may have a specific gravity of at least about 2.5 g/cc. Bulk density is the dry weight of the granules divided by the volume they occupy, including interstitial spaces between granules. Bulk density is measured by measuring the volume of a standard weight (100 grams) of granules using a graduated cylinder. In some embodiments, the granules have a moisture absorption of not more than or less than five, four, or three percent by weight as determined by the Water Absorption test method for particles described in the examples, below.

Granules which may be modified to have a hydrophobic surface treatment to provide granules of the present disclosure may further include those selected from commercially available materials. Suitable examples of commercially available additional granules which may be useful include those from 3M Company, St. Paul, MN, for example, under the trade designations “3M CLASSIC ROOFING GRANULES”, “3M COOL ROOFING GRANULES”, “3M COPPER ROOFING GRANULES”, “3M SMOG-REDUCING GRANULES”, “3M HIGHLY REFLECTIVE GRANULES”, “3M BLENDED ROOFING GRANULES”, and combinations thereof. For example, copper containing roofing granules, available from 3M Company, St. Paul, MN, as #6000, #7000, #7050, or #7070, may be useful.

In some embodiments, the granules useful in the roofing granules and articles of the present disclosure are porous. In some embodiments, porous, mineral-based granules comprise at least one of expanded shale, expanded slate, or expanded clay. In some embodiments, the porous, mineral-based granules comprise at least 5, 10, 15, 20, 25, or 30 percent by weight quartz. In some embodiments, the porous, mineral-based granules comprise less than 60, 50, 49, 48, 47, 46, 45, 44, 43, 42, 41, or 40 percent by weight aluminosilicate. In some embodiments, the porous, mineral-based granules are composite granules. In some embodiments, the porous, mineral-based granules are synthetic granules. In some embodiments, the porous, mineral-based granules comprise expanded shale or expanded slate, in some embodiments, expanded shale. In some embodiments, the porous, mineral-based granules comprise haydite. Minerals such as shale, slate, and clay are available from mines in various locations. Expanded porous, mineral-based granules can be obtained from Acrosa, Inc. (Mooresville, Indiana) in a variety of grades. The material may optionally be crushed and screened to have a desirable particle size. In some embodiments, the granules have a size in the range of about 300 μm to about 1800 μm or to about 2400 μm. In some embodiments, the granules have a size distribution in which at least 90 percent, at least 95 percent, or at least 97 percent of the granules are in the range of about 300 micrometers (μm) to about 1800 μm or to about 2400 μm.

In expanded mineral materials (e.g., expanded shale, expanded slate, and expanded clay), heating causes the formation of internal gas, producing a porous structure which is retained upon cooling. The material contains minerals (e.g., carbonates) that produce gas at the same temperature as the material begins to sinter (that is, soften before melting). This allows the material to expand, and rapid cooling preserves the expanded voids. The composition of the mineral and the temperature of the heat treatment affect the amount of the expansion of the shale, slate, or clay, which affects the porosity and moisture absorption. The temperature of the heat treatment affects the strength of the resultant granule. In some embodiments, the heat-treated, porous, mineral granules are heat-treated at a temperature of greater than 900° C., greater than 1000° C., or at least 1100° C. In some embodiments, the heat-treated, porous, mineral-based granules are heat-treated at a temperature of at least 1000° C. In some embodiments, the heat-treated, porous, mineral-based granules are heat-treated at a temperature less than the melting temperature of the mineral, in some embodiments up to about 2400° F. (1316° C.) or 2300° F. (1260° C.). Heating can be carried out in a rotary kiln or another suitable apparatus.

Water absorption can be evidence of porosity in porous granules. In some embodiments, the porous, mineral-based granules useful in the granules and construction articles of the present disclosure have a moisture absorption of at least 5, 6, or 7 percent by weight as determined using the Water Absorption test method for particles described in the examples, below. In some embodiments, the porous, mineral-based granules have a moisture absorption of at least 8, 9, 10, 11, 12, 13, 14, 15, or 16 or greater than 15 percent by weight. In some embodiments, the porous, mineral-based granules have a moisture absorption of up to 40, 30, or 20 percent by weight. Not all expanded shale, expanded slate, or expanded clay, for example, would necessarily have the same moisture absorption as determined using the test method described in the examples, below. As described above, the temperature of the heat-treatment affects the expansion of the material, which may influence the moisture absorption. Heat-treatment at less than 900° C. may or may not provide minerals with a moisture absorption of less than seven percent by weight. Furthermore, providing one or more coatings on the surface of the granules as described in further detail below decreases the moisture absorption of the granules. Such coatings may reduce the porosity of the granules. In some embodiments, the porous granules have a surface porosity of greater than 10, 15, or 20 percent as determined by mercury porosimetry or an equivalent method.

In some embodiments, the porous granules useful in the granules and construction articles of the present disclosure have a bulk density in a range from 30 pounds per cubic foot to 70 pounds per cubic foot (0.48 grams per cubic centimeter (g/cc) to 1.12 g/cc), measured as described above. In some embodiments, the porous, mineral-based granules useful in the granules and construction articles of the present disclosure have a bulk density in a range from 30 pounds per cubic foot to 65 pounds per cubic foot, 30 pounds per cubic foot to 60 pounds per cubic foot, 40 pounds per cubic foot to 60 pounds per cubic foot, 50 pounds per cubic foot to 60 pounds per cubic foot or 45 pounds per cubic foot to 50 pounds per cubic foot (0.48 g/cc to 1.04 g/cc, 0.48 g/cc to 0.96 g/cc, 0.64 g/cc to 0.96 g/cc, 0.80 g/cc to 0.96 g/cc or 0.72 g/cc to 0.80 g/cc). In these embodiments, the porous granules advantageously have a reduced shipping weight relative to standard roofing granules.

While in some embodiments, the porous, mineral-based granules useful in the granules and construction articles of the present disclosure have a lower bulk density relative to standard roofing granules, heat-treated porous, mineral-based granules are generally tough and can provide protection to a construction article. In some embodiments, the porous, mineral-based granules have an Abrasion Resistance of Roofing Granules of less than three percent, less than 2.5 percent, or less than two percent as determined by the Asphalt Roofing Manufacturers Association (ARMA) Granule Test Procedures Manual, form number 441-REG-96.

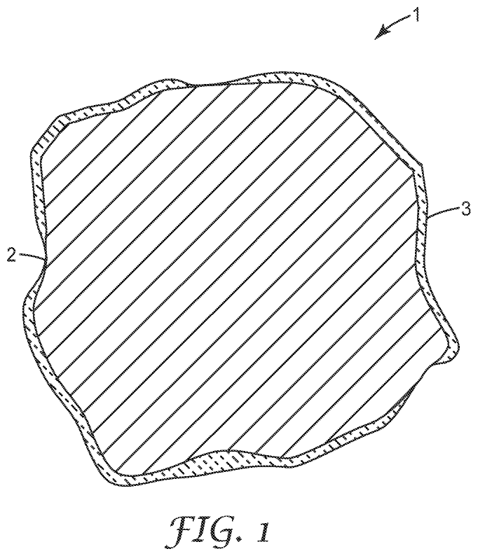

Referring now to FIG. 1, granules 1 of the present disclosure and useful in the construction articles of the present disclosure include a hydrophobic surface treatment 3 applied over at least a portion of the surface of a granule 2. Coatings on the porous, mineral-based granules 2 may be continuous or discontinuous, may have variable thicknesses, and may include incidental voids, which may be acceptable in some cases, such as when the coating still provides the desired effect. Although not shown in the embodiment of FIG. 1, additional coatings (e.g., 2 to 5 coating layers) may also be useful.

The hydrophobic surface treatment on granules of the present disclosure and useful in the construction articles of the present disclosure include a silicon-containing polymer. The hydrophobic surface treatment may be used in the absence of other coatings as described below in any embodiments. In some embodiments, the hydrophobic surface treatment is used in combination with a ceramic coating as described below in any of its embodiments. In some embodiments, the hydrophobic surface treatment is applied over the ceramic coating on the granules. Silicone polymer coatings and hydrocarbons (e.g., hydrocarbon oils such as petroleum oils, naphthenic oil, and aromatic oils and oleic acid) have been suggested to improve the handling of the material or to enhance the adhesion of the coated substrate to other substrates. Traditionally, slate oil, such as that available from Cross Oil & Refining Co. Inc., Smackover, AR, has been utilized for dust control. Hydrophobic surface treatments may be applied to granules during the cooling step of a coating process, described below, for example. Hydrophobic surface treatments can also be applied by mixing the granules and a silicon-containing polymer in oil (e.g., petroleum oil, naphthenic oil, and aromatic oil) or another solvent (e.g., organic solvent, water, or a combination thereof).

In some embodiments, the process for making the granules of the present disclosure includes combining granules, the silicon-containing polymer or a precursor thereof (e.g., a silane or siliconate), and optionally hydrocarbon oil to provide a mixture and at least one of heating or drying the mixture to provide the granules having a hydrophobic surface treatment. Heating can be carried out at for example, at least 50° C., 60° C., 70° C., 80° C., 90° C., or 100° C. Heating can be useful, for example, for reacting the surface treatment to form silicon-containing polymers, for drying the mixture to remove solvent or water, or both. Drying can be carried out at room temperature or any of these elevated temperatures. Heating can be carried out before, during, or after combining the granules and the silicon-containing polymer or a precursor thereof (e.g., a silane or siliconate) and optionally hydrocarbon oil. In some embodiments, the mixture includes the hydrocarbon oil (e.g., petroleum oil, naphthenic oil, and aromatic oil). In some embodiments, the mixture includes water.

Silicon-containing polymers useful as hydrophobic coatings include silicone (i.e., polysiloxane), silsesquioxane, silicate polymers, among others. Combinations of these polymers may be useful as well as combinations of any of these polymers with silanes. When the surface treatment is applied, it may be in the form of a silicon-containing polymer, a precursor thereof, or a combination thereof. Examples of precursors of silicone-containing polymers include silanes and siliconates. In some embodiments, the silicon-containing polymer is not fluorinated and/or is not derived from a fluorinated silane. In some embodiments, any silane present is not fluorinated.

A silicone polymer (i.e., polysiloxane) generally comprises divalent units independently represented by formula X:

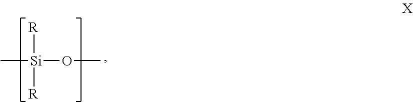

wherein each R is independently alkyl, aryl, arylalkylenyl, or heterocycloalkylenyl, wherein alkyl and arylalkylenyl are unsubstituted or substituted with halogen and optionally interrupted by at least one catenated —O—, —S—, —N(R″)—, or combination thereof (in some embodiments, —O—, —S—, and combinations thereof, or —O—), wherein aryl, arylalkylenyl, and heterocycloalkyenyl are unsubstituted or substituted by at least one alkyl, alkoxy, halogen, or combination thereof. R″ is hydrogen, alkyl, aryl, or arylalkylenyl, wherein aryl and arylalkylenyl are unsubstituted or substituted by at least one alkyl, alkoxy, or combination thereof. In some embodiments, R″ is hydrogen or alkyl, for example, having 1 to 4 carbon atoms (e.g., methyl, ethyl, n-propyl, isopropyl, n-butyl, isobutyl, or sec-butyl). In some embodiments, R″ is methyl or hydrogen. In some embodiments, the halogen or halogens on the alkyl, aryl, arylalkylenyl, or heterocycloalkylenyl groups is fluoro. In some embodiments, the alkyl group is perfluorinated. Suitable alkyl groups for R in formula X typically have 1 to 10, 1 to 8, 1 to 6, or 1 to 4 carbon atoms. Examples of useful alkyl groups include methyl, ethyl, isopropyl, n-propyl, n-butyl, iso-butyl, and iso-octyl. In some embodiments, each R is independently alkyl having up to 8 (in some embodiments, up to 6, 4, 3, or 2) carbon atoms. In some embodiments, each R is methyl.

Useful silicone polymers can have —SiR₃ groups at the terminal positions, that is, on each end of the divalent unit represented by formula X. In these cases, the silicone polymer lacks reactive functional groups. In some embodiments, useful silicone polymers have functional groups in at least one of the terminal positions and/or include divalent units in the siloxane backbone that have pendant functional groups, for example, vinyl, mercapto, amino, hydroxyl, or hydride functional groups. The functional groups may be useful, for example, for crosslinking.

In some embodiments, the silicon-containing polymer backbone is represented by formula:

—[(R¹)₂SiO]ₓ—[(R′)(R²)SiO)]_{y}—

where each R′ independently represents a long-chain hydrocarbon group, each R¹ independently represents hydrogen or a short-chain hydrocarbon group, R² represents R′ or R¹, x is in a range from 0 to 300, and y is in a range from one to 300. It is to be understood that formula —[(R¹)₂SiO]ₓ[(R′)(R²)SiO)]_{y}— implies no particular order of units [(R¹)₂SiO] and [(R′)(R²)SiO)]. These units may be located randomly throughout the polysiloxane backbone. It is to be further understood that each R′, R¹, and R² group may be the same or different from other R′, R¹, and R² groups, respectively.

The long-chain hydrocarbon group R′ has 6 to about 40 carbon atoms. The long-chain hydrocarbon group may be, for example, a straight chain or branched aliphatic group (e.g., alkyl, alkenyl, or alkynyl), such as hexyl, octyl, decyl, dodecyl, pentadecyl, octadecyl, triacontyl, octylenyl, pentadeylenyl, and nonacosylenyl; a polyoxyalkylenyl containing about 6 to 20 carbon atoms such as polyoxyhexylenyl, polyoxydecylenyl, polyoxyhexadecylenyl, and polyoxyicosylenyl; a substituted or unsubstituted aryl group having 6 to 14 ring atoms such as phenyl, benzyl, naphthyl, anthracenyl, phenanthrenyl, cumenyl, or mesityleny; an aralkyl having 6 to 14 ring atoms such as 2-phenylpropyl, beta-phenylethyl, and 2 or 3-naphthylpropyl; or carboxyl or ester group having 5 to about 20 carbon atoms and derived from molecules such as lauric acid, mystyric acid, stearic acid, methylhexanoate, methyloctanoate, and methyloctadecanoate; a carbo- or heterocyclic group having 5 to 10 ring atoms such as cyclopentyl, cyclohexyl, pyranyl, pyridyl and morpholinyl. In some embodiments, R′ does not contain atoms other than carbon and hydrogen atoms and is a straight chain or branched aliphatic group having 10 to 30 carbon atoms or 16 to 20 carbon atoms. The short chain hydrocarbon groups in some embodiments of R¹ may be an alkyl or alkenyl having up to 4 carbon atoms, in some embodiments, up to 3 or up to 2 carbon atoms. The alkyl group may be, for example, methyl, ethyl, propyl, isopropyl, butyl, and sec-butyl. In some embodiments, R¹ is methyl. In some embodiments, at least 80 molar percent or at least 90 molar percent of the R¹ and R² groups are methyl. In some embodiments, all R¹ groups are methyl. In some embodiments, all R¹ and R² groups are methyl. The polysiloxanes may have terminal groups of the formula —Si(R²)₃ or —Si(R¹)₃, in some embodiments, —Si(CH₃)₃. The terminal groups may be the same or different. The polysiloxanes having a backbone represented by formula —[(R′)₂SiO]—[(R′)(R²)SiO)]_{y}— generally have average molecular weights of about 1000 to 50,000, more typically about 1,800 to about 20,000. There is generally up to about 300 silicon atoms in the polysiloxane having a long-chain hydrocarbon group. Typically, there are about 15 to 150 silicon atoms in the polysiloxane. The polysiloxanes generally will have up to about 50 long-chain hydrocarbon groups; y therefore usually ranges from about 1 to about 50. In some embodiments, y is 30 or less, 10 or less, or 2 to 3. In some embodiments, x is in a range from 3 to 250, in some embodiments, less than about 90.

In some embodiments, the hydrophobic surface treatment does not include a silicon-containing polymer backbone can be represented by formula —[(R¹)₂SiO]x-[(R)(R²)SiO)]y— as described above in any of its embodiments.

A silsesquioxane is an organosilicon compound with the empirical chemical formula RSiO3/2 where Si is the element silicon, O is oxygen and R is as described above. Thus, silsesquioxanes polymers comprise silicon atoms bonded to three oxygen atoms. Silsesquioxanes polymers that have a random branched structure are typically liquids at room temperature. Silicates have the empirical chemical formula SiO4/2.

In some embodiments, the silicon-containing polymer comprises at least one of polyoctyltrimethoxysilane, polyisooctyltrimethoxysilane, a potassium methyl siliconate polymer, polymethylhydrogensiloxane, polydimethylsiloxane, aminofunctional polydimethylsiloxane, aminoalkyl polydimethylsiloxane, polymethylsiloxane, or a potassium propyl silanetriolate polymer. The silicon-containing polymer may be hydrophobic, water-dispersible, emulsified, or combinations thereof. Suitable examples of the silicon-containing polymers include “SILRES BS68”, which is a polyoctyltrimethoxysilane-containing composition that is available from Wacker Chemie AG, Munich, Germany; “SILRES BS60”, “SILRES BS 1802”, “SILRES BS 5160”, and “SILRES BS 4004US”, which are polyoctyltrimethoxysilane-containing emulsions available from Wacker Chemie AG; “SILRES BS16”, which is a potassium methyl siliconate that is available from Wacker Chemie AG; “SILRES BS94”, which is a polymethylhydrogensiloxane that is available from Wacker Chemie AG; “SILRES BS1001A”, which is an emulsified methyl siloxane that is available from Wacker Chemie AG; “SILRES BS1360”, which is an emulsified aminofunctional polydimethylsiloxane that is available from Wacker Chemie AG; “SILRES BS1306”, which is an emulsified aminoalkyl polydimethylsiloxane that is available from Wacker Chemie AG; and/or “SILRES BS45”, which is an emulsified polymethylsiloxane that is available from Wacker Chemie AG, and “TK-290 Final Seal”, which is a 20% solids oligomeric organosiloxane in aromatic solvent.

When applied, the silicon-containing polymer may also include silanes such as alkyltrialkoxysilanes, wherein the alkyl groups can be any of those described above for R, and wherein the alkoxy groups generally have up to 4, 3, or 2 carbon atoms. One suitable example an alkyltrialkoxysilane is isooctyltrimethoxysilane available in combination with an oligomer thereof in “SILRES BS68”, available from Wacker Chemie AG.

Silicon-containing polymers have been reported to treat granules to improve adhesion to asphalt.

A range from 0.0025 percent by weight to 0.05 percent by weight of silicone-containing polymer based on the weight of granules has been proposed. Conventional wisdom has suggested that silicon-containing polymers work as adhesion promoters up to a certain loading level and then start to act like a “release liner” causing the granules not to stick to an asphalt shingle. We have unexpectedly found that granule adhesion does not appear to be adversely affected by much higher loading levels of a silicon-containing polymer. In some embodiments, the amount of silicon-containing polymer on the granules is greater than 0.05, in some embodiments, at least 0.055 or 0.06 percent based on the weight of the granules. In some embodiments, the amount of silicon-containing polymer on the granules is greater than 0.25, in some embodiments, at least 0.255 or 0.26 percent, based on the weight of the granules. In some embodiments, the amount of silicon-containing polymer on the granules is greater than 0.50, in some embodiments, at least 0.55 or 0.56 percent based on the weight of the granules. In some embodiments, the amount of silicon-containing polymer on the granules in an amount of up to 0.5, 1.0 or 5.0 percent, based on the weight of the granules. In some embodiments, the amount of silicon-containing polymer on the granules in a range from 0.06 percent by weight to 0.2 percent by weight, in a range from 0.055 percent by weight to 0.5 percent by weight, in a range from 0.3 percent by weight to 0.5 percent by weight, or in a range from 0.26 percent by weight to 0.5 percent by weight. Such granules were found to have good adhesion to shingles to the touch, that is, they do not rub off easily by hand. As shown in a comparison of Example 14 and the Illustrative Examples in Table 5 below, when the amount of silicon-containing polymer was increased tenfold from 0.007 percent by weight to 0.07 percent by weight, the percentage of asphalt lost in the “Texas Boil” asphalt adhesion test decreased. Additionally, such granules were found to exhibit greater than 180 minutes of water repellency using the method described in the Examples below. Further unexpectedly, when such granules are coated onto an asphalt shingle, these granules have demonstrated a rapid rate of drying when the shingle is wet as compared to standard treated granules made into shingles.

In some embodiments, if the granules are porous, the silicon-containing polymer may be present on the porous granules in an amount of 0.35 percent by weight to five percent by weight, greater than 0.5 percent by weight to five percent by weight, 0.55 percent by weight to 5 percent by weight, 0.6 percent by weight to five percent by weight, 0.15 percent by weight to four percent by weight, 0.26 percent by weight to five percent by weight, or one percent by weight to five percent by weight, based on weight of the granules. We have found that a silicon-containing polymer can be applied at a larger weight percent on porous granules than on non-porous granules due to the porosity and typically lower density of the porous, mineral-based granules. The amount of hydrophobic surface treatment can affect the moisture absorption of porous, mineral-based granules. As shown in Illustrative Example 1 and Example 2, below, an uncoated rotary kiln-expanded shale granule has a moisture absorption of about 16 percent by weight.

When the same granule is provided with a silicon-containing polymer coating at a level of about four percent by weight, the granule has a moisture absorption of about 6.3 percent by weight.

In some embodiments, the hydrocarbon oil is present in an amount of at least 0.025, 0.05, 0.075, or 0.1 percent by weight of the granules. In some embodiments, the hydrocarbon oil is present in an amount of 5, 4, 3, 2, or 1 percent or less, by weight of the granules.

In some embodiments, granules useful in the granules and construction articles of the present disclosure comprise a ceramic coating, which, in some embodiments, may be a cementitious coating. In some embodiments, the coating is formed from an aqueous slurry of alkali metal silicate, an aluminosilicate, an optional borate compound, and an optional further inorganic material such as at least one of a pigment, biological growth inhibitor, or photocatalyst as described in further detail below. The alkali metal silicate and the aluminosilicate act as an inorganic binder and are typically a major constituent of the coating. As a major constituent, the inorganic binder is present at an amount greater than any other component and in some embodiments present at an amount of at least about 50 volume percent of the coating. In a granule that includes a ceramic coating with a pigment, the granules have a surface color different from an interior color. In some of these embodiments, the color is white. In other of these embodiments, the color is not white.

Aqueous sodium silicate is a useful alkali metal silicate due to its availability and cost, although equivalent materials such as potassium silicate may also be substituted wholly or partially therefore. The alkali metal silicate may be designated as M₂O:SiO₂, where M represents an alkali metal or combination of alkali metals such as sodium (Na), potassium (K), or a mixture of sodium and potassium. A variety of weight ratios of SiO₂ to M₂O may be useful. In some embodiments, the weight ratio of SiO₂ to M₂O ranges from about 1.4:1 to about 3.75:1. In some embodiments, the weight ratio of SiO₂ to M₂O ranges from about 2.75:1 to about 3.22:1. The weight ratio of SiO₂ to M₂O may be selected, for example, depending on the color of the granular material to be produced, with a lower ratio useful when light colored granules are produced and a higher ratio useful when dark colored granules are desired.

Aluminosilicates useful in a ceramic coating include a clay having the formula Al₂Si₂O₅(OH)₄, kaolin, Al₂O₃·2SiO₂·2H₂O, and its derivatives formed either by weathering (kaolinite), by moderate heating (dickite), or by hypogene processes (nakrite). The particle size of the clay is not critical; however, in some embodiments, the clay contains not more than about 0.5 percent coarse particles (particles greater than about 0.002 millimeters in diameter). Other useful aluminosilicate clays for use in the ceramic coating of the granule useful in the granules and construction articles of the present disclosure are commercially available, for example, “ACTI-MIN RP-2” from Active Minerals International LLC, Sparks, MD, and “KaMIN 95”, KaMIN Performance Minerals LLC, Macon, GA.

The optional borate compound, when incorporated, is typically present at a level of at least about 0.05 percent by weight of granules and not more than about 0.3 percent by weight of granules. Various borate compounds may be useful including sodium borate (e.g., available as “BORAX”, U.S. Borax Inc., Valencia, California), zinc borate, sodium fluoroborate, sodium tetraborate-pentahydrate, sodium perborate-tetrahydrate, calcium metaborate-hexahydrate, potassium pentaborate, potassium tetraborate, and mixtures thereof. Another useful borate compound is sodium borosilicate obtained by heating waste borosilicate glass to a temperature sufficient to dehydrate the glass.

In an example of a useful process for forming a ceramic coating, granules useful in the granules and construction articles of the present disclosure are preheated to a temperature range of about 125° C. to 140° C. in a rotary kiln or another suitable apparatus, and then are coated with the aqueous slurry of alkali metal silicate, an aluminosilicate, and an optional borate compound to form a plurality of slurry-coated granules. The water flashes off, and the temperature of the granules drops to a range of about 50° C. to 70° C. The slurry-coated granules are then heated for a time and at a temperature sufficient to form a plurality of ceramic-coated granules. Typically, the slurry-coated granules are heated at a temperature of about 315° C. to about 530° C. for a time ranging from about one minute to about ten minutes. Those skilled in the art will recognize that shorter times may be useful at higher temperatures. Crosslinkers (e.g., Lewis acids such as AlCl₃) may optionally be used in the process to crosslink the silicates. The heat may be generated by the combustion of a fuel, such as a hydrocarbon gas or oil, in an electric oven, or in a fluid bed or batch reactor.

In some embodiments, the coating, which may be a ceramic coating, on the granules useful in the granules and articles of the present disclosure comprises a pigment. Pigments may be included in the coating to obtain a desired color in the granules and articles of the present disclosure. Suitable pigments include compounds such as carbon black, titanium dioxide, chromium oxide, yellow iron oxide, phthalocyanine green and blue, ultramarine blue, red iron oxide, metal ferrites, mixed metal oxide pigments, other conventional pigments, and mixtures thereof. The mean particle sizes of the noted pigments may vary. Those skilled in the art are capable of determining the identity and amounts of pigments needed in a coating to achieve a specific color, in view of the color of the uncoated granule. The pigment can be added to the aqueous slurry of the alkali metal silicate, aluminosilicate, and optional borate compound and incorporated into the coating using the process described above, for example. The desired color of the granules may be influenced by the conditions of combustion of fuel during the coating process (e.g., time, temperature, and percent oxygen the combustion gases). Two different coatings with different pigments may be applied to the granules sequentially to achieve the desired color or other effect. Further details on coatings including pigments and processes for coating granules can be found, for example, in U.S. Pat. No. 6,238,794 (Beesley), U.S. Pat. No. 5,411,803 (George et al.), and U.S. Pat. No. 3,479,201 (Sloan).

The granules useful for the granules and articles of the present disclosure may be white or non-white as determined by the CIELAB color space scale established by the International Commission on Illumination. CIELAB indicates values with three axes: L*, a*, and b*. (Me full nomenclature is 1976 CIE L*a*b* Space.) The central vertical axis represents lightness (signified as L*) whose values run from 0 (black) to 100 (white). The color axes are based on the fact that a color cannot be both red and green, or both blue and yellow, because these colors oppose each other. On each axis the values run from positive to negative. On the a-a′ axis, positive values indicate amounts of red while negative values indicate amounts of green. On the b-b′ axis, yellow is positive, and blue is negative. For both axes, zero is neutral gray.

For the purposes of this application, granules and articles having a color falling within the inverted conical volume defined by the equation:

-(L*)+[((L₀*)+(y(a*)\hat{ }2+z(b*)\hat{ }2)\hat{ }0.5)/x]≤0

where L₀*=67, x=1.05, y=1.0, z=1.0 and the values, L*, a*, and b*, are defined on the CIE L*a*b* scale are said to be white and articles having a color falling outside the cone are said to be non-white. Values of the color space corresponding to white fall within the cone close to the vertical L* axis, are not strongly colored as indicated by their small displacements along either or both of the a* and b* axes, and have a relatively high degree of lightness as indicated by an L* greater than L_{0*}. L₀* is the vertex of the cone.

In some embodiments, pigments can be selected to have enhanced reflectivity in the near-infrared (NIR) portion of the solar spectrum (700 nanometers (nm) to 2500 nm), for example, having a reflectivity of at least about 20% at substantially all points in the wavelength range from 770 nm to 2500 nm or a summed reflectance value of at least about 7,000 as measured in the range between 770 and 2500 nm inclusive. The NIR comprises approximately 50% to 60% of the sun's incident energy, and improved reflectivity in the NIR portion of the solar spectrum leads to significant gains in energy efficiency. For the purposes of this disclosure, reflectivity is measured with a Perkin Elmer Lambda 900 Spectrophotometer fitted with a PELA1000 integrating sphere accessory. This sphere is 150 mm (6 inches) in diameter and complies with ASTM methods E903, D1003, and E308 as published in “Standards on Color and Appearance Measurement,” Third Ed., ASTM, 1991. By summed reflectance value is meant the sum of the numerical value of the discrete percentage reflectance measured at 5 nm intervals in the range from 770 nm to 2500 nm inclusive.

Examples of suitable pigments that can be useful in NIR-reflective coatings for the granules include titanium dioxide (TiO₂), transition metal oxides, and mixed metal oxides available, for example, from Ferro Corp., Cleveland, Ohio and the Shepherd Color Company, Cincinnati, Ohio.

Enhanced reflectivity in the NIR can be obtained, in some embodiments, by first providing a reflective primary coating to the granules and then providing a reflective secondary coating over the reflective primary coating with the reflective secondary coating containing a non-white pigment. After the primary coating, the granules may have a minimum direct solar reflectance value of at least 25%. By direct solar reflectance is meant that fraction reflected of the incident solar radiation received on a surface perpendicular to the axis of the radiation within the wavelength range of 300 to 2500 nm as computed according to a modification of the ordinate procedure defined in ASTM Method G159. A spreadsheet, available upon request from Lawrence Berkley Laboratory, Berkley, CA, combining the direct and hemispherical Solar Irradiance Air Mass 1.5 data from ASTM method G159 can be used to compute interpolated irradiance data at 5 nm intervals in the region of interest. The 5 nm interval data can be used to create weighting factors by dividing the individual irradiances by the total summed irradiance from 300 to 2500 nm. The weighting factors can then be multiplied by the experimental reflectance data taken at 5 nm intervals to obtain the direct solar reflectance at those wavelengths. After providing the second coating, granules having a reflectivity of at least about 20% at substantially all points in the wavelength range from 770 nm to 2500 nm or a summed reflectance value of at least about 7,000 as measured in the range from 770 to 2500 nm inclusive can be obtained. In some embodiments, the combination of the first reflective coating and the second reflective coating provide the non-white roofing granule with a CIELAB L* value of less than about 69. More details regarding granules with NIR reflectivity can be found, for example, U.S. Pat. No. 7,919,170 (Gross et al.).

In some embodiments, the coating, which may be a ceramic coating, on the granules useful in the granules and articles of the present disclosure comprises a biological growth inhibitor. In some embodiments, the biological growth inhibitor is adjacent to the coating rather than being a constituent of the coating itself. In yet other embodiments, a biological growth inhibitor will be present in both the coating and adjacent to the coating. In some embodiments, the biological growth inhibitor includes metal compounds, particularly oxides such as metal oxides selected from TiO₂, ZnO, WO₃, SnO₂, CaTiO₃, Fe₂O₃, MoO₃, Nb₂O₅, TiXZr₍₁₋ₓ₎O₂, SiC, SrTiO₃, CdS, GaP, InP, GaAs, BaTiO₃, KnbO₃, Ta₂O₅, Bi₂O₃, NiO, Cu₂O, CuO, SiO₂, MoS₂, InPb, RuO₂, CeO₂, Ti(OH)₄, or combinations thereof. Other copper compounds useful as biological growth inhibitors include cupric bromide, cupric stearate, cupric sulfate, cupric sulfide, cuprous cyanide, cuprous thiocyanate, cuprous stannate, cupric tungstate, cuprous mercuric iodide, and cuprous silicate, or mixtures thereof. The term “biological growth inhibitor” includes both those materials which kill micro biota and those which significantly retard the growth of micro biota. The biological growth inhibitors such as the metallic compounds described above can be added to the aqueous slurry of the alkali metal silicate, aluminosilicate, and optional borate compound and incorporated into the coating using the process described above, for example. The metallic compounds are typically available as particles, and a variety of particle sizes may be useful. For example, the copper compounds described above may have a median particle size of at least seven pm, at least one pm, at least five nm, at least ten nm, at least 20 nm, or not more than five, four, or three pm. Useful copper containing algicidal compounds are further described in U.S. Pat. No. 8,808,756 (Gould et al.).

Many of the metal compounds described above as biological growth inhibitors are also useful as photocatalysts. Photocatalysts, upon activation or exposure to sunlight, establish both oxidation and reduction sites. These sites are capable of preventing or inhibiting the growth of algae on the substrate or generating reactive species that inhibit the growth of algae on the substrate. In other embodiments, the sites generate reactive species that inhibit the growth of biota on the substrate. The sites themselves, or the reactive species generated by the sites, may also photooxidize other surface contaminants such as dirt, soot, or pollen. Photocatalytic elements are also capable of generating reactive species which react with organic contaminants converting them to materials which volatilize or rinse away readily. For these reasons, photocatalysts may be referred to as a self-cleaning component of the coating. Photocatalytic elements are also capable of generating reactive species which react with contaminants in the air. For example, the airborne gaseous pollutant Nox may be oxidized to form a nitrate salt. Suitable photocatalysts include TiO₂, ZnO, WO₃, SnO₂, CaTiO₃, Fe₂O₃, MoO₃, Nb₂O₅, TiXZr₍₁₋ₓ₎O₂, SiC, SrTiO₃, CdS, GaP, InP, GaAs, BaTiO₃, KnbO₃, Ta₂O₅, Bi₂O₃, NiO, Cu₂O, SiO₂, MoS₂, InPb, RuO₂, CeO₂, Ti(OH)₄, combinations thereof, and inactive particles coated with a photocatalytic coating. In some embodiments, the photocatalytic particles are doped with, for example, at least one of carbon, nitrogen, sulfur, or fluorine. In some embodiments, the dopant may be a metallic element such as Pt, Ag, or Cu. The doping material may be useful for modifying the bandgap of the photocatalytic particle. In some embodiments, the transition metal oxide photocatalyst is nanocrystalline TiO₂(e.g., nanocrystalline anatase TiO₂), and in some embodiments, the transition metal oxide photocatalyst is nanocrystalline ZnO. Photocatalysts are further described in U.S. Pat. No. 6,569,520 (Jacobs) and U.S. Pat. Appl. Pub. No. 2005/0142329 (Anderson et al.).

In some embodiments, a coating on the granules can include biological growth inhibitor such as those described U.S. Pat. No. 7,459,167 (Sengupta et al.). Such a biological growth inhibitor may be incorporated into the hydrophobic coating composition as described above, or it may be applied as a separate coating.

As described above, one or more coatings can be provided on the granules to achieve particular properties (e.g., color, infrared-reflectivity, photocatalytic activity, biological growth inhibition, and hydrophobicity). More than one coating can be provided on the granules to provide more than one desirable property. For example, granules may be coated with one or more ceramic coatings (e.g., including a pigment, biological growth inhibitor, or photocatalyst) and a hydrophobic surface treatment as described above.

A “combination thereof” include blends of granules that have some granules with one type of coating and other granules with a different type of coating as well as granules having multiple types of coatings on the same granules.

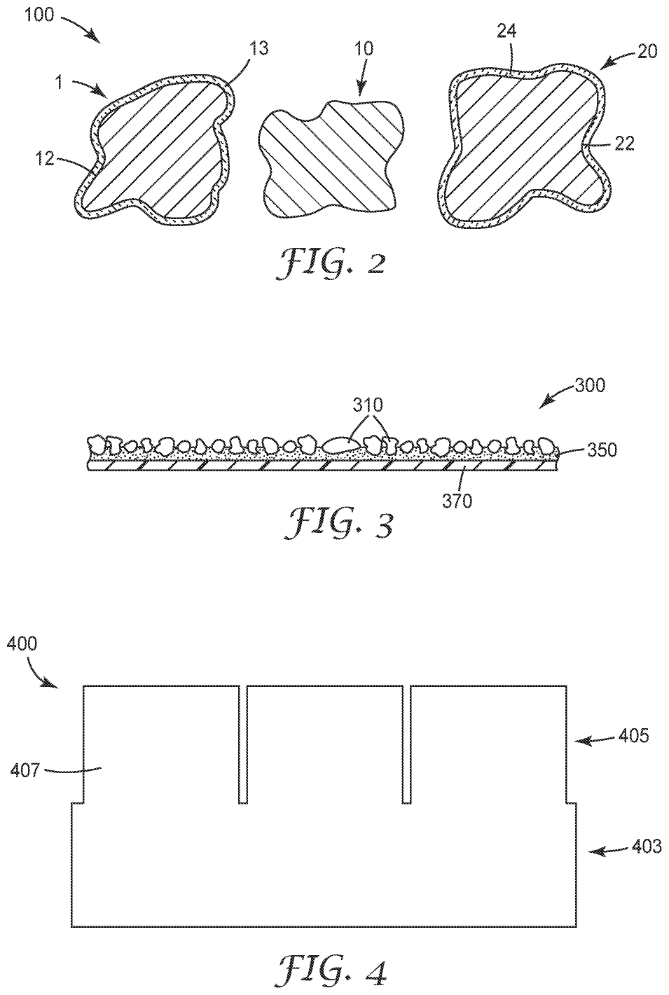

Referring now to FIG. 2, an embodiment of a blend 100 of granules having a hydrophobic surface treatment and additional granules useful in the granules and construction articles of the present disclosure is shown. In some embodiments, including the embodiment illustrated in FIG. 2, the blend includes porous, mineral-based granules 10 that are uncoated. In other embodiments, a coating such as a hydrophobic polymeric coating can applied over at least a portion of the surface of at least some porous, mineral-based granules 10. The blend 100 further includes granules 1, which include a base granule 12 and a hydrophobic surface treatment 13 as described above in any of its embodiments applied over at least a portion of the surface of base granule 12. The blend 100 further includes granules 20, which include a base granule 22 and a ceramic coating 24 as described above in any of its embodiments applied over at least a portion of the surface of base granule 22. Although FIG. 2 illustrates continuous coatings, coatings 13 and 24 on the base granules 12 and 22 may be continuous or discontinuous, may have variable thicknesses, and may include incidental voids, which may be acceptable in some cases, such as when the coating still provides the desired effect. Although not shown in the embodiment of FIG. 2, additional layers also may be useful on additional granules 1 and 20. For example, at least some of the granules can include a hydrophobic surface treatment over a ceramic coating.

The blend of the porous, mineral-based granules and the additional granules 20 and optionally 10, including the blend as illustrated in FIG. 2, can provide a variety of advantageous properties. A typical roof in North America is wet with dew six to twelve hours a day. The amount of time that a roof is wet with dew and/or rain, “wet time”, correlates to the rate of growth of discoloring algae on the roof surface.

The present disclosure provides granules that typically and advantageously can reduce the level of moisture retained on a roofing material and/or reduce the amount of contact with the moisture by hydrophobic “beading up”, thereby reducing “wet time”. For example, although this disclosure is not to be bound by any theory, it is believed that in a blend of porous, mineral-based granules 10, which may have a moisture absorption of at least seven percent by weight, and granules having a hydrophobic surface treatment, as described above in any of their embodiments, the hydrophobic granules can cause water to bead up on the surface of the blend of granules, where it may be more easily absorbed by the porous, mineral-based granules and then desorbed as a result of environmental effects thereby reducing the level of moisture retained on a roofing material. Environmental inputs affecting a roofing system and the contributions of these inputs have been reported as ultraviolet light (4.6%), infrared (IR) light (27.2%), visible light (23.3%), wind (18%), temperature and humidity (15.8%), precipitation (4.5%), and structure (6.8%). In some embodiments, the blend of granules can include additional granules having a ceramic coating that includes a dark-colored pigment. The additional granules having a dark-colored coating may provide a thermal capacitor for the thermal energy useful for the desorption process.

The granules may also be blended with other reflective materials, for example, particles of multi-layer optical film that reflect infrared light. Examples of such particles include those described in U.S. Pat. No. 9,498,931 (Jacobs et al.). The reflective particles can also be useful in a blend with both porous, mineral-based granules and the granules having a hydrophobic surface treatment as described above in any of their embodiments.

The present disclosure provides construction articles that include the granules as described above in any of their embodiments. The construction article includes a substrate, an organic coating, and the granules or blend of granules according to the present disclosure. Suitable construction articles include shingles, roll roofing, cap sheets, stone coated tile, as well as other non-roofing surfaces (e.g., walls, roads, walkways, and concrete). An embodiment of a construction article is shown in FIG. 3. FIG. 3 shows a construction article 300 including a plurality of granules 310 according to the present disclosure as described above in any of their embodiments. Construction article 300 includes an organic coating 350 that adheres granules 310 to a substrate 370.

The substrate in the construction article of the present disclosure may be porous or dense. Examples of suitable substrates include concrete, clay, ceramic (e.g., tiles), natural stone, and other non-metals. Additional examples of suitable substrates include roofs (e.g., metal roofs), synthetic roofing materials (e.g., composite and polymeric tiles), matting, and asphalt shingles. A variety of materials may be utilized as the matting for roofing materials. In general, the matting may comprise a non-woven matting of either fiberglass or cellulose fibers. Fiberglass matting is often used in the asphalt roofing products industry. However, cellulose matting, sometimes referred to as organic matting or rag felt, may also be utilized. Fiberglass matting is commercially available from Owens-Coming Fiberglass Corporation, Toledo, Ohio and Manville Roofing Systems, Denver, Colorado. It is recognized that any fiberglass mat with similar physical properties could be used with satisfactory results. Generally, the fiberglass matting is manufactured from a silicate glass fiber blown in a non-woven pattern in streams of about 30 pm to 200 pm in diameter with the resultant mat approximately 1 to 5 millimeters (mm) in thickness. Cellulose felt (dry felt) is typically made from various combinations of rag, wood, and other cellulose fibers or cellulose-containing fibers blended in appropriate proportions to provide the desirable strength, absorption capacity and flexibility.

In some embodiments of the construction article of the present disclosure, the organic coating is asphalt. Roofing asphalt, sometimes termed “asphalt flux”, is a petroleum-based fluid comprising a mixture of bituminous materials. In the manufacture of roofing materials, it is generally desirable to soak the absorbent felt or fiberglass matting until it is impregnated or saturated to the greatest possible extent with a “saturant” asphalt, thus the asphalt should be appropriate for this purpose. Saturant asphalt is high in oily constituents which provide waterproofing and other preservatives. Matting saturated with saturant asphalt are generally sealed on both sides by application of a hard or more viscous “coating asphalt” which itself is protected by the covering of roofing granules. In the case of fiberglass mat-based asphalt roofing products, it is understood that the coating asphalt can be applied directly to the unsaturated fiberglass mat. The asphalts used for saturant asphalt and the coating asphalt are generally prepared by processing the asphalt flux in such a way as to modify the temperature at which it will soften. In general, the softening point of saturant asphalt may vary from about 37° C. to about 72° C., whereas the softening point of desirable coating asphalt may run as high as about 127° C. The softening temperature varies among the roofing industry and may be modified for application to roof systems in varying climates.

Other organic coatings may be useful in the construction articles of the present disclosure. In some embodiments, the organic coating is an epoxy resin, which may be useful, for example, on a concrete substrate.

The present disclosure further provides a process of making a construction article of the present disclosure. The process includes applying an organic coating on a substrate and applying the granules of the present disclosure in any of their embodiments to the organic coating. The granules are typically partially embedded in the organic coating. Typically, at least a portion of the granules or aggregate are exposed to the environment, either initially or after a period of time. The organic coating and substrates may be any of those described above.

In some embodiments, the construction article of the present disclosure is a shingle. A schematic top view of a shingle is shown in FIG. 4. The shingle 400 includes a prime region 405, which is defined by tabs 407 and cutout sections, and a headlap region 403. The headlap region 403 is the region that is covered by adjacent shingles when installed on a roof while the prime region 405 is the region that is exposed when the shingle is installed on a roof. In some embodiments, the granules of the present disclosure, including the blends, are at least partially embedded in the organic coating in a prime region of the shingle.

As described above, the granules of the present disclosure can be useful for reducing the wet time of the construction articles of the present disclosure. Reducing the wet time of shingles on a roof, for example, can lead to reduced algae growth, reducing the need for algae-resistant granules. In some embodiments, the construction article of the present disclosure has a reduced wet time relative to a comparative construction article, wherein the comparative construction article comprises the granules having the hydrophobic surface treatment but in a lower amount based on the weight of the granules. In some embodiments, the construction article of the present disclosure has an increased water-desorption rate relative to a comparative construction article, wherein the comparative construction article comprises the granules having the hydrophobic surface treatment but in a lower amount based on the weight of the granules. As shown in the Examples, below, the rate of desorption of water for the shingle including roofing granules of the present disclosure is higher that of a shingle including only the commercially available granules. Furthermore, as shown in the Examples, below, in a shingle including the roofing granules of the present disclosure has different surface behavior than a shingle including commercially available granules. In shingles including commercially available granules, water is absorbed into the shingle and then forms a continuous bead at the lip of the shingle. A combination of uncoated porous, mineral-based granules and porous, mineral-based granules of the present disclosure having a hydrophobic surface treatment helps water to bead up on the surface of the shingle. This “beading up” may allow the water to be more easily absorbed by the porous, mineral-based granules and then desorbed as a result of environmental effects (e.g., solar radiation, wind, temperature, and relative humidity) as described above. The “beading up” effect can help keep moisture away from the asphalt coating on the shingles, reducing the ability of algae to grow.

### SOME EMBODIMENTS OF THE DISCLOSURE

In a first embodiment, the present disclosure provides roofing granules comprising a hydrophobic surface treatment, wherein the hydrophobic surface treatment comprises a hydrocarbon oil and a silicon-containing polymer, wherein the hydrocarbon oil is present in an amount of at least 0.025 percent by weight of the roofing granules, and the silicon-containing polymer is present in an amount of greater than 0.05 percent by weight of the roofing granules. In a second embodiment, the present disclosure provides the roofing granules of the first embodiment, wherein the hydrophobic surface treatment does not include a silicon-containing polymer having a backbone represented by formula:

—[(R¹)₂SiO]ₓ—[(R′)(R²)SiO)]_{y}—

wherein each R′ independently represents a long-chain hydrocarbon group having from 6 to 40 carbon atoms, each R¹ independently represents hydrogen or a short-chain hydrocarbon group having from 1 to 4 carbon atoms, R² represents R′ or R¹, x is in a range from 0 to 300, and y is in a range from one to 300.

In a third embodiment, the present disclosure provides roofing granules of the first or second embodiment, wherein the silicon-containing polymer is present in an amount of at least 0.055 percent or at least 0.06 percent by weight, based on the weight of the roofing granules. In a fourth embodiment, the present disclosure provides roofing granules of any one of the first to third embodiments, wherein the silicon-containing polymer is present in an amount up to 0.2 percent or up to 0.1 percent, based on the weight of the roofing granules. In a fifth embodiment, the present disclosure provides roofing granules comprising a hydrophobic surface treatment, wherein the hydrophobic surface treatment comprises a silicon-containing polymer, wherein the roofing granules have a surface color different from an interior color, and wherein the silicon-containing polymer is present in an amount of greater than 0.25 percent by weight of the roofing granules. In a sixth embodiment, the present disclosure provides roofing granules comprising a hydrophobic surface treatment, wherein the hydrophobic surface treatment comprises a silicon-containing polymer, and wherein the roofing granules are porous, and the silicon-containing polymer is present in an amount of greater than 0.5 percent by weight of the roofing granules. In a seventh embodiment, the present disclosure provides roofing granules comprising a hydrophobic surface treatment, wherein the hydrophobic surface treatment comprises a silsesquioxane polymer, and wherein the silsesquioxane polymer is present in an amount of greater than 0.05 percent by weight of the roofing granules. In an eighth embodiment, the present disclosure provides the roofing granules of the fifth, sixth, or seventh embodiment, wherein the silicon-containing polymer is present in an amount of at least 0.26 percent, 0.3 percent, 0.35 percent, or 0.5 percent by weight of the roofing granules. In a ninth embodiment, the present disclosure provides roofing granules of any one of the first to eighth embodiments, wherein the silicon-containing polymer is present in an amount up to 5.0 percent by weight of the roofing granules. In a tenth embodiment, the present disclosure provides the roofing granules of any one of the first to ninth embodiments, wherein the silicon-containing polymer is not fluorinated. In an eleventh embodiment, the present disclosure provides the roofing granules any one of the first to tenth embodiments, wherein the silicon-containing polymer comprises at least one of a silicone polymer or a silsesquioxane polymer. In a twelfth embodiment, the present disclosure provides the roofing granules of any one of the first to tenth embodiments, wherein the silicon-containing polymer is present on the granules in an amount of one percent by weight to five percent by weight, based on the weight of the granules.

In a thirteenth embodiment, the present disclosure provides the roofing granules of any one of the first to twelfth embodiments, wherein the roofing granules comprise porous, mineral-based granules. In a fourteenth embodiment, the present disclosure provides roofing granules comprising a blend of porous, mineral-based granules and the roofing granules comprising a hydrophobic surface treatment of any one of the first to twelfth embodiments. In a fifteenth embodiment, the present disclosure provides the roofing granules of the fourteenth embodiment, wherein at least some of the porous, mineral-based particles comprise a hydrophobic polymeric coating. In a sixteenth embodiment, the present disclosure provides the roofing granules of the fourteenth or fifteenth embodiments, wherein at least some of the porous, mineral-based granules are uncoated. In a seventeenth embodiment, the present disclosure provides the roofing granules of any one of the thirteenth to sixteenth embodiments, wherein the porous, mineral-based granules comprise at least one of expanded shale, expanded slate, or expanded clay. In an eighteenth embodiment, the present disclosure provides the roofing granules of the seventeenth embodiment, wherein the porous, mineral-based granules comprise expanded shale. In a nineteenth embodiment, the present disclosure provides the roofing granules of any one of the thirteenth to eighteenth embodiments, wherein the porous, mineral-based granules comprises haydite. In a twentieth embodiment, the present disclosure provides the roofing granules of any one of the thirteenth to nineteenth embodiments, wherein the porous, mineral-based granules are heat-treated at a temperature of at least 1000° C. In a twenty-first embodiment, the present disclosure provides the roofing granules of any one of the thirteenth to twentieth embodiments, wherein the porous, mineral-based granules have a moisture absorption of at least 7, 8, 9, or 10 percent by weight.

In a twenty-second embodiment, the present disclosure provides the roofing granules of any one of the first to twenty-first embodiments, wherein the roofing granules comprise a ceramic coating. In a twenty-third embodiment, the present disclosure provides the roofing granules of the twenty-second embodiment, wherein the ceramic coating is a cementitious coating. In a twenty-fourth embodiment, the present disclosure provides the roofing granules of the twenty-second or twenty-third embodiment, wherein the ceramic coating comprises a pigment. In a twenty-fifth embodiment, the present disclosure provides the roofing granules of the twenty-fourth embodiment, wherein the pigment is white. In a twenty-sixth embodiment, the present disclosure provides the roofing granules of the twenty-fourth embodiment, wherein the pigment is not white. In a twenty-seventh embodiment, the present disclosure provides the roofing granules of the twenty-fifth or twenty-sixth embodiment, wherein the pigment is infrared light-reflective. In a twenty-eighth embodiment, the present disclosure provides the roofing granules of any one of the twenty-second to twenty-seventh embodiments, wherein the ceramic coating comprises a biological growth inhibitor. In a twenty-ninth embodiment, the present disclosure provides the roofing granules of any one of the twenty-second to twenty-eighth embodiments, wherein the ceramic coating comprises a photocatalytic particle.

In a thirtieth embodiment, the present disclosure provides the roofing granules of any one of the first to twenty-ninth embodiments, wherein the roofing granules have a density in a range from 0.48 grams per cubic centimeter to 0.96 grams per cubic centimeter. In a thirty-first embodiment, the present disclosure provides the roofing granules of any one of the first to thirtieth embodiments, wherein the roofing granules have an Abrasion Resistance of Roofing Granules of less than three percent or less than two percent as determined by the ARMA Granule Test Procedures Manual, form number 441-REG-96.

In a thirty-second embodiment, the present disclosure provides the roofing granules of any one of the first to thirty-first embodiments, wherein the roofing granules have a moisture absorption of up to or less than 5, 4, or 3 percent by weight. In a thirty-third embodiment, the present disclosure provides the roofing granules of any one of the first to twenty-ninth embodiments, wherein the roofing granules have a density in a range from 1.28 grams per cubic centimeter to 1.92 grams per cubic centimeter.

In a thirty-fourth embodiment, the present disclosure provides use of the granules as described in any one of the first to thirty-third embodiments as roofing granules.

In a thirty-fifth embodiment, the present disclosure provides a process for making the roofing granules of any one of the first to thirty-fourth embodiments, the process comprising combining granules, the silicon-containing polymer or precursor thereof, and optionally the hydrocarbon oil to provide a mixture and at least one of heating or drying the mixture to provide the roofing granules. In a thirty-sixth embodiment, the present disclosure provides the process of the thirty-fifth embodiment, wherein the mixture comprises the hydrocarbon oil. In a thirty-seventh embodiment, the present disclosure provides the process of the thirty-fifth embodiment, wherein the mixture does not comprise the hydrocarbon oil. In a thirty-eighth embodiment, the present disclosure provides the process of any one of the thirty-fifth to thirty-ninth embodiments, wherein the mixture comprises water.

In a thirty-ninth embodiment, the present disclosure provides a construction article comprising a substrate, an organic coating, and the granules of any one of the first to thirty-fourth embodiments at least partially embedded in the organic coating. In a fortieth embodiment, the present disclosure provides a process of making the construction article of the thirty-ninth embodiment, the process comprising applying an organic coating on a substrate and applying the roofing granules of any one of the first to thirty-fourth embodiments to the organic coating. In a forty-first embodiment, the present disclosure provides the construction article or process of the thirty-ninth or fortieth embodiment, wherein the organic coating is an asphalt coating. In a forty-second embodiment, the present disclosure provides the construction article or process of the thirty-ninth, fortieth, or forty-first embodiment, wherein the construction article is a shingle. In a forty-third embodiment, the present disclosure provides the construction article or process of any one of the thirty-ninth to forty-second embodiments, wherein the roofing granules are at least partially embedded in the organic coating in a prime region of the shingle. In a forty-fourth embodiment, the present disclosure provides the construction article or process of any one of the thirty-ninth to forty-third embodiments, wherein the construction article has a reduced wet time relative to a comparative construction article, wherein the comparative construction article comprises roofing granules comprising the same silicone-containing polymer in a lower amount. In a forty-fifth embodiment, the present disclosure provides the construction article or process of any one of the thirty-ninth to forty-fourth embodiments, wherein the construction article has a faster water desorption rate relative to a comparative construction article, wherein the comparative construction article comprises the same silicone-containing polymer in a lower amount. In a forty-sixth embodiment, the present disclosure provides a method of reducing algae growth on a construction surface, the method comprising applying the construction article of or made by the process of any one of the thirty-ninth to forty-fifth embodiments onto the construction surface.

The following examples are provided to further illustrate aspects of the disclosure. The examples are not intended to limit the scope of this disclosure in any way.

### EXAMPLES

### Test Methods

### Water Repellency

Water repellency was tested by placing 25.0 grams (g) of granule examples, illustrative examples, or comparative examples into a 20-mL test tube, which was then inverted onto a flat surface, thereby forming a cone-shaped pile. A 15-mm diameter indent was then created by pressing the bottom of the test tube onto the tip of the cone-shaped pile. Three (3) drops of deionized water were carefully placed into the indent, and the amount of time for the bead to break up and sink down through the granules was recorded.

### Granule to Asphalt Adhesion “Texas Boil” Test

The Texas Boil Test is a modification of Texas Method Tex-530-C or ASTM D 3625, “Effect of Water on Bituminous-Coated Aggregate Using Boiling Water”. Instead of paving aggregate, #11 white roofing granules (+16 mesh) were used. 150 g of granules and 6.8 g of asphalt were heated to 325 degrees F. for one hour. The granules were stirred into the asphalt until evenly coated and allowed to cool. The asphalt/granule mix was boiled for 10 minutes. After cooling, the mixture was allowed to dry overnight. An ointment tin was filled with the granule plus asphalt mix and another was filled with the boiled and dried granule plus asphalt mix. A colorimeter was used to measure L* of the treated granules, L*(a), L* of the granules plus asphalt, L*(b), and L* of the boiled granules plus asphalt, L*(c). The % asphalt loss is calculated according to the equation:

% asphalt lost=(L*(c)−L*(b))/L*(a)−L*(b))×100

### Water Absorption

About 400 g of Illustrative Examples 1, 3, and 5, Example 2, and Comparative Examples 4 and 6 granules were placed in 100 mesh (0.149 millimeter (mm)) sieves. Water was run through the granules and sieve for 3 minutes while the granules were constantly stirred. The granules were deposited on a heavy paper towel on a laboratory bench. The wet pile of granules was flattened and then lightly patted with a heavy paper towel to remove excess water from the surface of the granules. At this stage the granules were considered saturated surface dry (SSD).

For the purposes of this disclosure SSD is defined as the condition in which the surface of the granules has no visible standing water, but the inter-particle voids are saturated with water. Water absorption % by mass (Am) is calculated by the following equation in which Mssd is the mass of SSD sample, and Mdry is the mass of oven dried test sample: (Am)=((Mssd)−(Mdry))/(Mdry).

To determine Mssd, the SSD granules were weighed on a digital balance in a pan. The pan was placed in an oven for a period of 12-24 hours. Example 2 and Illustrative Example 5 were dried at 140° F. (60° C.), and Illustrative Examples 1 and 3 and Comparative Examples 4 and 6 were dried at 350° F. (177° C.). The pan with the granules was then removed from the oven and reweighed to determine Mdry. Water absorption was then calculated from the equation above.

### Bulk Density

One hundred grams of material was poured into a graduated cylinder to measure the volume.

### Abrasion Resistance

Abrasion resistance was determined by the method in the Asphalt Roofing Manufacturers Association (ARMA) Granule Test Procedures Manual, form number 441-REG-96. An average of three measurements is reported.

### Absorption Capacity and Desorption Rate

An IR Bench was constructed in the laboratory to measure water desorption rates with a given IR heat load, with IR representing roughly 27% of the solar and environmental energy inputs as described above. The IR Bench was an enclosed humidity-controlled chamber with a sliding door for access. The test setup included a precision digital balance with 3200 g (grams) capacity and 0.01 g readability, available from Mettler Toledo, Columbus, Ohio. A 12-inch×12-inch× 7/16-inch (30.5 centimeter (cm)×30.5 cm×1.1 cm) Oriented Strand Board (OSB) surface was connected to two 2-inch×12-inch× ⅜-inch (5.08 cm×30.5 cm×0.95 cm) wood supports positioned on the digital balance. A roofing synthetic underlayment, obtained under the trade designation TIGER PAW ROOF DECK PROTECTION from GAF Company, Parsippany, New Jersey, was stapled to the top of the OSB.

The dry weight of the shingle tab of each of Illustrative Example 7, Examples 8 and 9 and Comparative Example 10 was measured using the digital balance and recorded. Each shingle tab was soaked in water in an Igloo Sportsman 120-quart Cooler for 24(X) twenty-four hours. Small ceramic cups were used for weighting down the shingle tab. The tab was removed from the cooler water and drained in a vertical position(90°) for 15 seconds. The tab was placed on heavy paper toweling to dry off back of shingle tab for 30 seconds and then weighed on the digital balance. The amount (grams) of water absorbed per shingle tab was the weight of the SSD granule and shingle weight minus the dry shingle tab weight. An example or comparative example shingle tab was placed on top of the underlayment for desorption rate, measured as water (g)/time (min).

Two commercial grade IR heaters (obtained from Protherm, LLC, Brandon, Minnesota) about 12 inches×24 inches in size were positioned 12 to 24 inches above the example or comparative example shingle tab surface. The faces of examples and comparative examples were parallel to the IR heaters. The enclosed chamber had a portable humidifier with a dial input for humidity setting. A Relative Humidity (RH) probe in the chamber gave RH levels, and two thermocouples provided the temperature of the process chamber. Three to five thermocouples were positioned on top of the example or comparative example shingle for surface temperature. Two heat flow modules with thermocouples were located between the OSB deck and the underlayment to provide the heat transfer and current temperature level. Two heat flow modules were placed on the underside of the OSB deck for heat flow readings.

A programmable logic controller (PLC), obtained under the trade designation MICROLOGIC 1400 from Allen Bradley, Milwaukee, Wisconsin, was used to collect all the inputs of the thermocouples, heat flow devices, RH probe, and precision balance. The program of the PLC controlled the IR heaters with on/off and percentages of power control depending on the surface temperature reading of the shingle thermocouples. An industrial automation software, obtained under the trade designation WONDERWARE from Aveva, Cambridge, United Kingdom, was used to display and record all device readings.

### Outdoor Evaluation 1

The construction of the panels consisted of using ¾-inch (1.9 cm) birch plywood. The size of the plywood is 24 inches wide×26 inches high×% inch thick (61 cm×66 cm×1.9 cm). The panel was built using typical residential shingle installation guidelines. First, a drip edge (2⅝ inches (6.56 cm)×1- 11/16 inch (4.29 cm)×24% inches (62 cm) Style-D available from Menards, Eau Claire, Wisconsin) was installed at bottom of the panel. A synthetic roofing underlayment, obtained under the trade designation TIGER PAW ROOF DECK PROTECTION from GAF Company (24 inches (61 cm)×26 inches (66 cm)), was installed on the drip edge and plywood deck. A starter strip shingle, Owens Coming Starter obtained from Owens Coming, Toledo, Ohio, was nailed in place using four %-inch (1.9 cm) galvanized roofing nails.

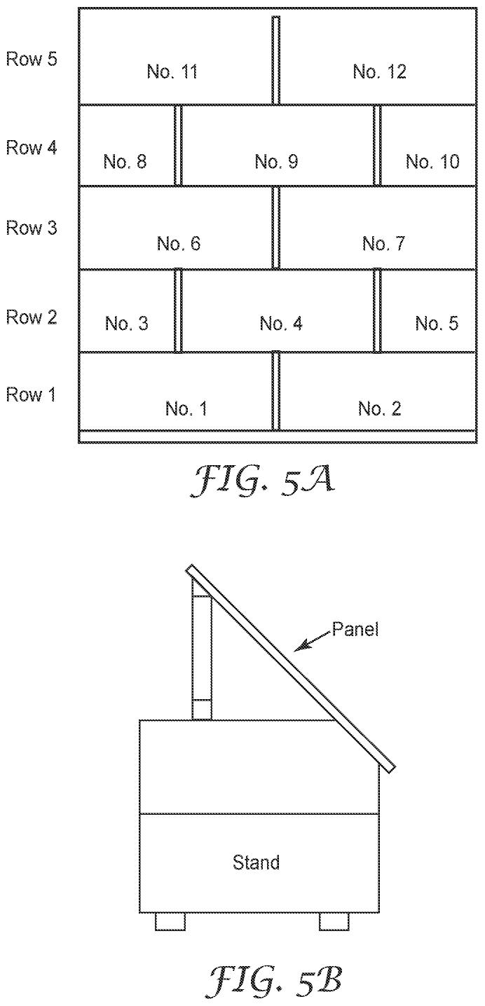

The Illustrative Example 7, Examples 8 and 9, and Comparative Example 10 shingles were punched to the 3-Tab shingle profile (36 inches (91.4 cm)×12 inches (30.5 cm)×0.13 inch (0.33 cm)) as described below. The 3-Tab shingles have an exposure of 5 inches (12.7 cm). Each tab is 12 inches (30.5 cm) long. For each Example, the first row (bottom) had two full tabs and nailed with four %-inch (1.9 cm) galvanized roofing nails. The second row (left to right) included half of a tab, then a full tab, and then half of a tab. A total of six %-inch (1.9 cm) galvanized roofing nails were used to nail the second row. The third row had two full tabs nailed with four %-inch (1.9 cm) galvanized roofing nails. The fourth row (left to right) included half of a tab, then a full tab, and then half of a tab. A total of six %-inch (1.9 cm) galvanized roofing nails were used to nail the fourth row. The fifth row had 2 full tabs at a width of about 6 inches (15.2 cm) nailed with four %-inch (1.9 cm) galvanized roofing nails. The panel layout is shown in FIG. 5A.

Each shingle panel was fastened to a 24-inch×24-inch×12-inch (61 cm×61 cm×30.5 cm) wooden stand made with standard 2 inch×6 inch wood construction at a 45° angle. The panels on their stands were positioned facing south (180°+/−5°). The stand is shown in FIG. 5B.

Starting before sunrise and every 10 minutes until panels appeared dry at a distance of 15 to 20 feet (4.6 m to 6.1 m) from the respective panel, panel temperatures were taken using an IRThermal Gun (Model 566 Thermal Gun Infrared & Contact Thermometer from Fluke) and IR picture using a Thermal Camera (FLIR Model E65). An iPhone was used to take panel pictures at various times during the drying process.

Outdoor Evaluation 2 Shingle panels were constructed using the method of the first two paragraphs of Outdoor Evaluation 1. Each shingle panel was fastened to 24-inch×24-inch×12-inch (61 cm×61 cm×30.5 cm) wooden stand made with standard 2 inch×6 inch wood construction at a 15° angle. The panels on their stands were placed on a 28-inch (71-cm)-high weathering table. The panels were positioned facing south(180°+/−5°).

The shingle panels were evaluated with three wetness sensors (WS) per panel. The first WS was located on the second row, middle tab at the lower right edge. The second WS was located on the third row, left tab in the upper right near the lip of the fourth row. The third WS was located on the fourth row, middle tab, at the right side middle of the tab. Each WS had two 6-32×1.50-inch (3.81-cm) long stainless steel setscrews that were spaced 0.457 inch (1.16 cm) apart, centerline to centerline. The setscrews were purchased from McMaster-Carr, Chicago, IL. The setscrews were screwed through a threaded Delrin bushing. The Delrin bushing was installed at the given shingle panel location. The Delrin bushing was installed through the plywood and shingles to the height where the bushing was flush with the respective granule plane of the top shingle tab with a target tolerance+0.000/−.030.

The level of moisture that was present on the shingles was measured by the continuity of the direct current (dc) voltage between the WS. A PLC obtained under the trade designation MICROLOGIC 1400 from Allen Bradley was used to collect all the inputs of the WS. The data collection software was run on a standard computer laptop. The laptop was connected to the PLC. The data collection software was from Indusoft, Austin, TX.

From the PLC/electrical cabinet, a ten volt of dc (vdc) signal was transmitted to one of the setscrews. The other or opposite setscrew was used to return the signal back the PLC/electrical cabinet. The signals were transmitted through a 18/2 solid shielded “Fire Alarm Cable.” The FPLR-18/2-1S-WSP cable was purchased from Sterling Wire & Cable, Minneapolis, MN. The 18/2 cable was connected to the two setscrews via No. 6 Red Insulated Ring terminal, 7113K35, that was purchased through McMaster-Carr. The ring terminal was fastened with two(2X) 6-32 nuts per setscrew. The 18/2 cable was connected to the PLC card for measuring return vdc.

Illustrative Examples (IE) 1, 3, and 5, Example (EX) 2, and Comparative Examples (CE) 4 and 6 Illustrative Example 1 Å “4×0 Grade” bulk super-sack bag of expanded shale was obtained from Arcosa, Inc. (Mooresville, IN). The expanded shale was screened for a roofing granule range [under 12 mesh (1.68 mm) and over 20 mesh (0.84 mm) size), washed, and oven dried. The washing process included running tap water through the sized material while on US Standard 100 mesh (0.149 mm) screen. The resulting grade range of Example 1 was 1-3% retained on a US Standard No. 12 mesh (1.68 mm), 36-42% retained on a US Standard No. 16 mesh (1.19 mm), 42-48% retained on a US Standard No. 20 mesh (0.84 mm), 9-15% retained on a US Standard No. 30 mesh (0.595 mm), 0-1% retained on a US Standard No. 40 mesh (0.4 mm), and 0-1% retained on the “pan” as determined using a “RO-TAP” Sieve Shaker, model RX-29, from W.S. Tyler, Mentor, Ohio. A color measurement was performed using a HunterLab Spectrocolorimeter LabScan XE (HunterLab Reston, Virginia), and the L*, a*, and b* values were L* 35.04, a* 3.44, and b* 6.72. Bulk density was measured using the method described above and determined to be 0.77 g/cc. Abrasion resistance was measured using the method described above and determined to be 1%.

### Example 2

At room temperature, one kilogram (kg) of the Illustrative Example 1 expanded shale roofing granules was batched mixed by hand with 200 g of an oligomeric organosiloxane, obtained as a 20% solids solution from TK Products (Minnetonka, MN) under the trade designation “TK 290 Final Seal”. The mixed batch was allowed to air dry for 24 hours. The organosiloxane was present on the granules at 4 weight percent (wt %) based on the weight of the granules.

### Example 2a

Example 2a was made as described for Example 2 except the organosiloxane was present on the granules at 3.2 weight percent (wt %) based on the weight of the granules.

### Illustrative Example 3

Illustrative Example 1 (500 g) was preheated to 200° F. (93° C.). To the preheated granules, 33.5 grams of a pigment slurry was added. The slurry comprised 15 parts kaolin clay (Acti-Min RP-2 from Active Minerals International LLC, Sparks, MD), 33.8 parts aqueous sodium silicate solution (39.4% solids, 2.75 ratio SiO2 to Na₂O) available from PQ Corp., Valley Forge, PA, 8.6 parts of deionized water, a dispersant (Rhodacal N from Solvay USA Inc, Princeton, NJ), 4.0 parts carbon black pigment N762 (Columbian Chemicals Company, Marietta GA), 1.0 part carbon black pigment N326 (Cancarb Limited Medicine Hat, Alberta Canada). The mixture of Illustrative Example 1 and pigment slurry was stirred until the granules were evenly coated and the granules were free flowing. The coated granules were then heated in a rotary kiln to a temperature of 900° F. (482° C.). The time to reach the target temperature was about 10 minutes at which time the granules were removed and allowed to cool.

### Comparative Example 4

3M #11 Grade Mineral, untreated, were obtained from 3M Wausau, WI. The mineral particles had a size range of 4-10% range retained on US Standard No. 12 mesh (1.68 mm), 30-50% range retained on a US Standard No. 16 mesh (1.19 mm), 20-40% range retained on a US Standard No. 20 mesh (0.84 mm), 10-30% retained on a US Standard No. 30 mesh (0.595 mm), 1-10% retained on a US Standard No. 40 mesh (0.4 mm) and 0-2% retained on the “Pan.”

### Example 5

The granules of Comparative Example 4 were washed by running tap water through the 3M #11 Grade while on US Standard 100 mesh screen and then oven dried. At room temperature, one kg of the dried granules was batched mixed by hand with 200 g of an oligomeric organosiloxane, obtained as an 8% solids solution from TK Products under the trade designation “TK 290 Final Seal”. The mixed batch was allowed to air dry for 24 hours. The mixed batch was oven dried for 18 hours at 140° F. (60° C.). The organosiloxane was present on the granules at 1.6 wt %, based on the weight of the granules.

Comparative Example 6 was “3M CLASSIC ROOFING GRANULES” WA5100 black ceramic coated granules, obtained from 3M Company, St. Paul, MN. These had the same size range as Comparative Example 4. EX 2, IE 1, 3, and 5, and CE 4 and 6 were evaluated using the Water Absorption and Water Repellency tests described above. The results are provided in Table 1, below.

TABLE 1
Water Absorption and Water Repellency for
EX 2, IE 1, 3, and 5, and CE 4 and 6

| Ex, IE, or CE | Water Absorption (%) | Water Repellency (minutes) |
|---|---|---|
| IE 1 | 16 | 0 |
| Ex 2 | 6.3 | >240 |
| IE 3 | 8.8 | Not measured |
| CE 4 | 3.8 | 0 |
| EX 5 | 2.4 | >240 |
| CE 6 | 3.4 | Not measured |

### Illustrative Examples (IE) 7 and 8, Example (EX) 9 and Comparative Example (CE) 10

Shingles were produced as a continuous roll with a width of 13 inches on a pilot line using typical industry methods for asphalt shingles. A fiberglass mat obtained under the trade designation “GLASBASE” from CertainTeed (Valley Forge, Pennsylvania) was used. An asphalt matrix was used that contained asphalt obtained under the trade designation “TRUMBULL” Base Asphalt 4411 from Owens Coming (Toledo, Ohio) and calcium carbonate filler obtained from Twin City Minerals Corp. (Savage, Minnesota). Illustrative Example 1 granules were used for Illustrative Example 7. A mixture of Illustrative Example 1 (35%) and “3M CLASSIC ROOFING GRANULES” WA7100 grey ceramic coated granules (65%) from 3M Company was used for Illustrative Example 8. A mixture of Illustrative Example 1 (35%), “3M CLASSIC ROOFING GRANULES” WA7100 grey ceramic coated granules (40%), and Example 2a granules (25%) was used for Example 9. “3M CLASSIC ROOFING GRANULES” WA7100 grey ceramic coated granules were used for Comparative Example 10. From the continuous roll, the shingles were cut-punched down to a standard 3-Tab shingle size (36 inches (91.4 cm)×12 inches (30.5 cm)×0.13 inch (0.33 cm)), which were evaluated using the Outdoor Evaluation. Illustrative Example 7 and 8, Example 9, and Comparative Example 10 were trimmed to a test size of 12 inches×12 inches×0.13 inch (30.5 cm×30.5 cm×0.33 cm) for the evaluation of Absorption Capacity and Desorption Rate.

“3M CLASSIC ROOFING GRANULES” WA7100 grey ceramic coated granules from 3M Company had the same size range as Comparative Example 4 and a color measured using a HunterLab Spectrocolorimeter LabScan XE of L* 35.84, a* 1.75, b* 5.44.

The Absorption Capacity and Desorption Rate for Illustrative Examples 7 and 8, Example 9, and Comparative Example 10 were evaluated at 50% RH using the test method described above. The weight of each tab, water weight for each example over time, the Absorption Capacity, and the Desorption Rate are shown in Table 2, below.

TABLE 2
Absorption Capacity and Desorption Rate
for IE 7, IE 8, EX 9, and CE 10

| | Example | | | |
|---|---|---|---|---|
| | IE 7 | IE 8 | EX 9 | CE 10 |
| | Tab Weight (g) | | | |
| Time | 363.3 | 386.4 | 383.8 | 422.5 |
| (minutes) | Weight (g) | Weight (g) | Weight (g) | Weight (g) |
| 0 | 16.87 | 18.40 | 14.20 | 8.79 |
| 2 | 15.26 | 17.83 | 13.50 | |
| 4 | 14.46 | 17.04 | 14.18 | |
| 6 | 13.44 | 14.83 | 12.32 | |
| 8 | 11.42 | 12.64 | 9.45 | 7.29 |
| 10 | 9.32 | 10.87 | 7.25 | 4.67 |
| 12 | 7.32 | 8.93 | 5.25 | 2.80 |
| 14 | 5.37 | 7.20 | 3.72 | 1.23 |
| 16 | 3.82 | 5.55 | 2.56 | 0.38 |
| 18 | 2.77 | 4.01 | 1.90 | 0.26 |
| 20 | 1.85 | 2.89 | 1.66 | 0.53 |
| 22 | 1.18 | 1.96 | 1.47 | 0.32 |
| 24 | 0.74 | 1.35 | 1.36 | 0.17 |
| 26 | 0.30 | 0.92 | 1.36 | 0.01 |
| 28 | 0.00 | 0.55 | 1.20 | 0.00 |
| 30 | | 0.29 | | |
| 32 | | 0.00 | | |
| 34 | | | | |
| Heater Accumulation | 0.047 | 0.047 | 0.037 | 0.053 |
| Segments | | | | |
| Absorption Capacity | 0.12 | 0.13 | 0.10 | 0.06 |
| (g/sq. in.) | | | | |
| Desorption Rate | −0.66 | −0.64 | −0.55 | −0.34 |
| water(g/minute) | | | | |

### Outdoor Evaluation of Illustrative Example 7, Example 9, and Comparative Example 10

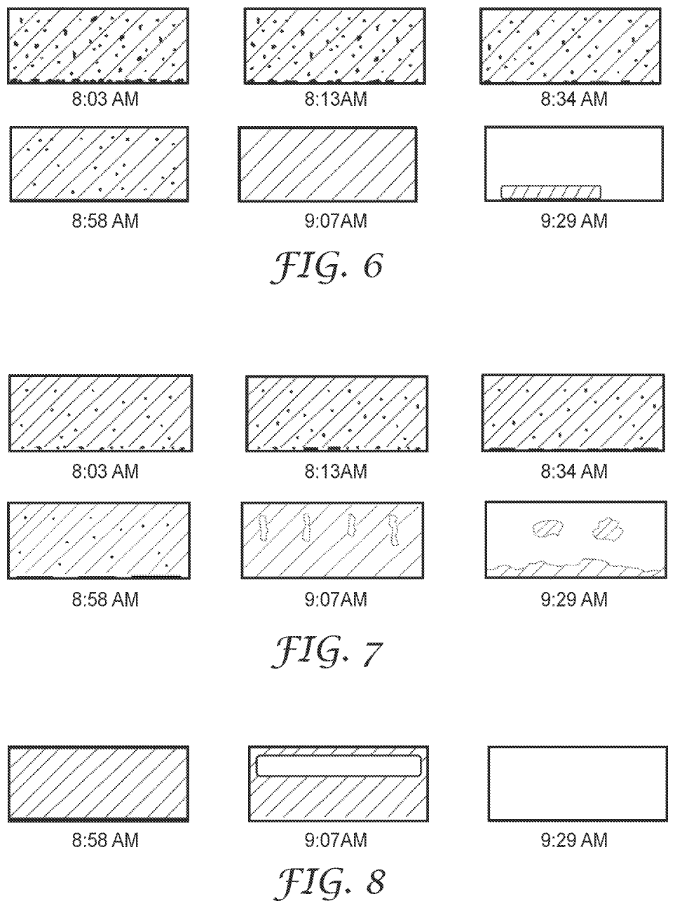

Illustrative Example 7, Example 9, and Comparative Example 10 were evaluated using the Outdoor Evaluation 1 method described above. In FIGS. 6, 7, and 8, a wet surface is represented as diagonal lines, for example, as shown in FIG. 6, 9:07 a.m., and a dry surface is represented with no shading, for example, as shown in FIG. 8, 9:29 a.m. Combinations of these representations depict dry areas within wet areas or vice versa.

During the time from 6:50 a.m. to 7:40 a.m. and with IR temperature readings taken every 10 minutes as shown in Table 3, Illustrative Example 7 showed water lipping in each row at the respective tab edge starting with the readings at 6:50 a.m. Water lipping is where water gathers at the shingle's tab edge and is depicted as solid (FIG. 6, 8:58 a.m.) or intermittent (FIG. 6, 8:03 a.m.). At the 7:00 a.m. reading, the water lipping appeared to be intermittent at the tab's edges for each of the rows. By 7:20 a.m., the dew-moisture began to show signs of hydrophilic and hydrophobic beading on the Illustrative Example 7 surface. The hydrophilic beading had very irregular, flat forms as shown in FIG. 6, 8:13 a.m. During the time from 7:40 a.m. to 8:50 a.m., Illustrative Example 7 showed intermittent water lipping and distinguished water beading properties in each row at the respective tab edge starting with the readings at 7:40 a.m. At 8:00 a.m., the water beading action was progressing with some hydrophilic beading and some hydrophobic beading, which was more spherically shaped. FIG. 6 8:03 a.m., 8:13 a.m., and 8:34 a.m. visually depict this progression. During the time from 9:00 AM to 9:40 a.m., Illustrative Example 7 showed water lipping progressing to a visual dry condition at 15 to 20 feet away. Edge dripping was occurring, water beads streaking, and spot drying was taking place. FIG. 6 8:58 a.m., 9:07 a.m., 9:29 a.m. visually depict this progression. All tabs appeared dry from 15 to 20 feet away at 9:34 a.m.

During the time from 7:40 a.m. to 8:50 a.m., Example 9 showed little to some intermittent water lipping at the tab edges and water beading in each row starting with the readings at 7:40 a.m. At 8:00 a.m., the water beading was progressing with spherical shaped beads. At the 8:34 period mark, light continuous lipping with several gaps per tab edge was observed. FIG. 7 8:03 a.m., 8:13 a.m., and 8:34 a.m. visually depict this progression. During the time from 9:00 AM to 9:40 a.m., Example 9 showed a visual spotty/streaky dry condition at 15 to 20 feet away. Flatter water hydrophobic/hydrophilic beads were seen blending into the typography of the granule matrix. Some edge dripping was occurring, and spot drying was taking place. FIG. 7 8:58 a.m., 9:07 a.m., 9:29 a.m. visually depict this progression. All tabs appeared dry from 15 to 20 feet away at 9:43 a.m.

During the time from 6:50 a.m. to 7:40 a.m. and with IR temperature readings taken every 10 minutes as shown in Table 3, Comparative Example 10 showed heavy water lipping on Rows 2-5 at the tabs' edges starting with the readings at 6:50 a.m. The water lipping on Row No. 1 was less than the above rows. Outside of the water lipping at the respective tab's edges, the wetness of the panel appeared to very be uniform with just being wet with no or just one water bead forming. During the time from 7:40 a.m. to 8:50 a.m., Comparative Example 10 continued to show medium to heavy water lipping on Rows 2-5 at the respective tabs' edges starting with the readings at 7:40 a.m. Comparative Example 10 showed no hydrophobic or hydrophilic beading. The dew-moisture appeared to be just soaking into the roofing granule matrix observations. The tabs appeared generally as shown in FIG. 8 8:58 a.m., with more or less water lipping at the edge. During the time from 9:00 AM to 9:40 a.m., Comparative Example 10 continued to show water lipping to a dry condition at 15 to 20 feet away. Typical tab drying was taking place from top to bottom of the tab. There was no individual spot drying and or streak drying. FIG. 8 8:58 a.m., 9:07 a.m., 9:29 a.m. visually depict this progression. All tabs appeared dry from 15 to 20 feet away at 9:29 a.m.

Visual inspection from 12 inches to 18 inches (30.5 cm to 46 cm) away at 9:40 a.m., Comparative Example 10 showed more moisture in the asphalt/granule matrix than Illustrative Example 7 and Example 9. During the 3-hour observation period, Illustrative Example 7 and Example 9 dynamically moved moisture to surface of granules for the typical tab and lower edge while in Comparative Example 10, moisture soaked into the asphalt/granule matrix, and the lower edge of the tabs had a continuous lipping line of water on the lower edge. It appeared that the solar and environmental effects are better able to evaporate the total moisture per shingle tab at a faster rate from Illustrative Example 7 and Example 9 where water beaded up on the surface versus the water soaked in the asphalt/granule matrix of Comparative Example 10.

TABLE 3
Outdoor Evaluation Temperatures for IE 7, EX9, and CE 10

| | | | IE 7 | EX 9 | CE10 |
|---|---|---|---|---|---|
| | | Air | Temper- | Temper- | Temper- |
| | | Temp. | ature | ature | ature |
| | | ° F., | ° F. | ° F. | ° F. |
| Time | | (° C.) | (° C.) | (° C.) | (° C.) |
| 6:50-7:40 | a.m. | 35 | 29.5-26.1 | 28.8-25.7 | 28.5-25.6 |
| | | (1.7) | (−1.4-−3.3) | (−1.8-−3.5) | (−1.9-−3.6) |
| 8:00-8:30 | a.m. | 37-41 | 31.2-46.5 | 31.2-42.7 | 30.8-42.6 |
| | | (2.8-5) | (−0.44-8.06) | (−0.44-5.94) | (−0.67-5.89) |
| 8:40-9:10 | a.m. | 43-45 | 59.2-65.9 | 52.1-63.8 | 55.8-66.9 |
| | | (6.1-7.2) | (15.1-18.8) | (11.2-17.7) | (13.2-19.4) |
| 9:20-9:40 | a.m. | 46-47 | 66.6-83.8 | 61.3-79.1 | 63.1-82.8 |
| | | (7.8-8.3) | (19.2-28.8) | (16.3-26.2) | (17.3-28.2) |
| 10:20 | a.m. | 51 | 107.2 | 102.6 | 105.3 |
| | | (10.6) | (41.8) | (39.2) | (40.7) |
| 11:40 | a.m. | 58 | 128.6 | 128.8 | 126.7 |
| | | (14.4) | (53.7) | (53.8) | (52.6) |
| 3:00 | p.m. | 65 | 138.9 | 136.0 | 136.7 |
| | | (18.3) | (59.4) | (57.8) | (58.2) |

### Illustrative Examples 11 to 13, 15, and 16, and Examples 14 and 17 to 20

For each of Illustrative Examples 11 to 13, 15, and 16, and Examples 14 and 17 to 20, 1000 grams (g) of “3M CLASSIC ROOFING GRANULES” WA9300 white ceramic coated granules not coated with oil or silicone (obtained from 3M Wausau, WI) were placed in a 360° F. (182° C.) laboratory oven for at least 2 hours. The granules were removed from the oven and mixed with 15 grams of deionized water. The granules were allowed to continue mixing for 45 seconds at which time a mixture of petroleum hydrocarbon naphthenic oil (available as Cross L500 from Cross Oil Refining and Marketing of Arkansas) and silicone (Silicone Water Repellant BS68 available from Wacker Chemical Corp. of Michigan) in the amounts indicated in Table 4, below, were added to the mixing granules. The granules were allowed to continue mixing for 5 minutes. The granules were then placed in an oven set at 176° F. (80° C.) for one hour. The amounts of naphthenic oil, silicone, and the water repellency for each of Illustrative Examples 11 to 13, 15, and 16, and Examples 14 and 17 to 20 are shown in Table 4, below. Asphalt adhesion was measured using the “Texas Boil” Test, and the results are shown in Table 5, below.

TABLE 4
Illustrative Examples 11 to 13, 15, and 16, and Examples 14 and 17 to 20

| EX | IE 11 | IE 12 | IE 13 | EX 14 | IE 15 | IE 16 | EX 17 | EX 18 | EX 19 | EX 20 |
|---|---|---|---|---|---|---|---|---|---|---|
| Silicone (g) | 0.07 | 0.21 | 0.42 | 0.7 | 0.07 | 0.5 | 1.0 | 1.5 | 2.5 | 3.5 |
| Oil (g) | 2.0 | 2.0 | 2.0 | 2.0 | 2.0 | 2.0 | 2.0 | 2.0 | 1.0 | 0.0 |
| Water | >240 | 200 | 240 | >240 | 264 | 285 | 282 | 270 | 240 | 216 |
| Repellency | | | | | | | | | | |
| (minutes) | | | | | | | | | | |

TABLE 5
Texas Boil results for Illustrative Examples 11
to 13, 15, and 16, and Examples 14 and 17 to 20

| | Granules | | | Granules + Asphalt | | | Boild Granules + Asphalt | | | |
|---|---|---|---|---|---|---|---|---|---|---|
| EX | L* | a* | b* | L* | a* | b* | L* | a* | b* | % Asphalt Lost |
| IE 11 | 67.86 | −0.49 | 1.33 | 13.52 | 0.95 | 1.19 | 17.76 | 1.18 | 3.19 | 7.80% |
| IE 12 | 67.86 | −0.49 | 1.33 | 14.6 | 1.1 | 1.42 | 19.1 | 1.09 | 3.26 | 8.45% |
| IE 13 | 67.86 | −0.49 | 1.33 | 14.94 | 0.91 | 1.22 | 19.04 | 1.05 | 3.07 | 7.75% |
| EX 14 | 67.86 | −0.49 | 1.33 | 15.25 | 1.19 | 1.42 | 18.23 | 0.98 | 2.83 | 5.66% |
| IE 15 | 67.86 | −0.49 | 1.33 | 14.56 | 1.29 | 1.57 | 21.55 | 1.25 | 3.83 | 13.11% |
| IE 16 | 67.86 | −0.49 | 1.33 | 15.77 | 1.26 | 1.36 | 19.94 | 1.18 | 3.48 | 8.01% |
| EX 17 | 67.86 | −0.49 | 1.33 | 15.99 | 1.72 | 2.3 | 19.89 | 1.17 | 3.42 | 7.52% |
| EX 18 | 67.86 | −0.49 | 1.33 | 14.58 | 1.43 | 1.67 | 19.77 | 1.16 | 3.51 | 9.74% |
| EX 19 | 67.86 | −0.49 | 1.33 | 14.98 | 1.28 | 1.6 | 20.07 | 0.98 | 3.22 | 9.63% |
| EX 20 | 67.86 | −0.49 | 1.33 | 14.63 | 1.45 | 1.82 | 21.1 | 1.03 | 3.22 | 12.15% |

### Examples 21 and 22 and Illustrative Examples 23 and 24

Examples 21 and 22 and Illustrative Examples 23 and 24 were made according to the method of Illustrative Examples 11 to 13, 15, and 16, and Examples 14 and 17 to 20 with the modification that 1000 g of black roofing granules (“3M CLASSIC ROOFING GRANULES” WAS100 black ceramic coated granules from 3M company) were used instead of the white roofing granules. The amounts of naphthenic oil and silicone, and the water repellency for each of Examples 21 and 22 and Illustrative Examples 23 and 24 are shown in Table 6, below.

TABLE 6
Examples (EX) 21 and 22 and Illustrative Examples (IE) 23 and 24

| EX | EX 21 | EX 22 | IE 23 | IE 24 |
|---|---|---|---|---|
| Silicone (g) | 0.7 | 1.4 | 0.07 | 0.035 |
| Oil (g) | 2.0 | 2.0 | 2.0 | 2.5 |

### Example 25, Comparative Example 26, and Illustrative Example 27

Shingles were prepared as described above for Illustrative Examples (IE) 7 and 8, Example (EX) 9 and Comparative Example (CE) 10. A mixture of Example 17 (25%), “3M CLASSIC ROOFING GRANULES” WA7100 grey ceramic coated granules (40%), and Example 2a granules (35%) was used for Example 25. “3M CLASSIC ROOFING GRANULES” WA9300 white ceramic coated granules obtained from 3M Company were used for Comparative Example 26. A mixture of Illustrative Example 1 (35%) and “3M CLASSIC ROOFING GRANULES” WA9300 white ceramic coated granules (65%) from 3M Company was used for Illustrative Example 27.

### Outdoor Evaluation of Illustrative Examples 7 and 27, Comparative Examples 10 and 26, and Example 25

Illustrative Example 7, Comparative Example 10, Example 25, Comparative Example 26, and Illustrative Example 27 were evaluated using the Outdoor Evaluation 2 method described above. The evaluation took place in Tampa, Florida. The time at which the WS first detected moisture, the time the next morning at which the WS last detected moisture, and the total time that moisture was detected on the shingle panels (i.e., Total Wet Time) was recorded and is reported in Table 7, below.

TABLE 7
Outdoor Evaluation of Illustrative Examples (IE) 7 and 27,
Comparative Examples (CE) 10 and 26, and Example (EX) 25

| | Evening | Morning | Total |
|---|---|---|---|
| Example | Start Time | End Time | Wet Time |
| IE 7 | 23:40 | 8:40 | 9 hours |
| CE 10 | 21:50 | 9:00 | 11 hours 10 minutes |
| IE 27 | 21:40 | 9:00 | 11 hours 20 minutes |
| CE 26 | 20:30 | 9:20 | 12 hours 50 minutes |
| EX 25 | 21:00 | 8:40 | 11 hours 40 minutes |

This disclosure is not limited to the above-described embodiments but is to be controlled by the limitations set forth in the following claims and any equivalents thereof. This disclosure may be suitably practiced in the absence of any element not specifically disclosed herein.

We claim:

1. Roofing granules comprising a hydrophobic surface treatment, wherein the hydrophobic surface treatment comprises a hydrocarbon oil and a silicon-containing polymer, wherein the hydrocarbon oil is present in an amount of at least 0.025 percent by weight of the roofing granules, and the silicon-containing polymer is present in an amount of greater than 0.05 percent by weight of the roofing granules.

2. The roofing granules of claim 1, wherein the hydrophobic surface treatment does not include a silicon-containing polymer having a backbone represented by formula:
—[(R¹)₂SiO]ₓ—[(R′)(R²)SiO)]_{y}—
wherein each R′ independently represents a long-chain hydrocarbon group having from 6 to 40 carbon atoms, each R¹ independently represents hydrogen or a short-chain hydrocarbon group having from 1 to 4 carbon atoms, R² represents R′ or R¹, x is in a range from 0 to 300, and y is in a range from one to 300.

3. The roofing granules of claim 1, wherein the silicon-containing polymer is present in an amount up to 5.0 percent by weight of the roofing granules.

4. The roofing granules of claim 1, wherein the roofing granules comprise porous, mineral-based granules.

5. The roofing granules of claim 1, wherein the roofing granules comprise a ceramic coating.

6. The roofing granules of claim 5, wherein the ceramic coating comprises a white pigment, a non-white pigment, an infrared light-reflective pigment, a biological growth inhibitor, a photocatalytic particle, or a combination thereof.

7. The roofing granules of claim 1, wherein the silicon-containing polymer comprises at least one of a silicone polymer or a silsesquioxane polymer.

8. Roofing granules comprising a hydrophobic surface treatment, wherein the hydrophobic surface treatment comprises a silicon-containing polymer, wherein at least one of the following limitations is met:
the roofing granules have a surface color different from an interior color, and the silicon-containing polymer is present in an amount of greater than 0.25 percent by weight of the roofing granules;
the roofing granules are porous, and the silicon-containing polymer is present in an amount of greater than 0.5 percent by weight of the roofing granules, or
the silicon-containing polymer is a silsesquioxane polymer, and the silicon-containing polymer is present in an amount of greater than 0.05 percent by weight of the roofing granules.

9. The roofing granules of claim 8, wherein the silicon-containing polymer is present in an amount up to 5.0 percent by weight of the roofing granules.

10. The roofing granules of claim 8, wherein the roofing granules comprise porous, mineral-based granules.

11. The roofing granules of claim 10, wherein the porous, mineral-based granules comprise at least one of expanded shale, expanded slate, or expanded clay.

12. The roofing granules of claim 10, wherein the porous, mineral-based granules comprise haydite.

13. The roofing granules of claim 8, wherein the roofing granules comprise a ceramic coating.

14. The roofing granules of claim 13, wherein the ceramic coating comprises a white pigment, a non-white pigment, an infrared light-reflective pigment, a biological growth inhibitor, a photocatalytic particle, or a combination thereof.

15. The roofing granules of claim 8, wherein the silicon-containing polymer is not fluorinated.

16. The roofing granules of claim 8, wherein the silicon-containing polymer comprises the silsesquioxane polymer.

17. A construction article comprising:
a substrate;
an organic coating; and
the roofing granules of claim 8 at least partially embedded in the organic coating.

18. The construction article of claim 17, wherein the organic coating is an asphalt coating.

19. The construction article of claim 17, wherein the construction article is a shingle.

20. The construction article of claim 19, wherein the roofing granules are at least partially embedded in the organic coating in a prime region of the shingle.
